(19) United States
(12) Patent Application Publication
(10) Pub. No.: US 2026/0142705 A1
(43) Pub. Date: May 21, 2026

(54) METHOD AND DEVICE FOR MEASURING INTERFERENCE IN WIRELESS COMMUNICATION SYSTEM

(71) Applicant: Samsung Electronics Co., Ltd., Suwon-si, Gyeonggi-do (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR); Kyungjun CHOI, Suwon-si (KR)

(21) Appl. No.: 19/120,975

(22) PCT Filed: Oct. 19, 2023
(86) PCT No.: PCT/KR2023/016219

§ 371 Date: Apr. 14, 2025

(30) Foreign Application Priority Data
Nov. 1, 2022 (KR) 10-2022-0143919

(51) Int. Cl. H04B 7/06; H04L 5/00

(52) U.S. Cl. CPC H04B 7/0626; H04L 5/0007

(57) ABSTRACT

The present disclosure relates to a 5G or 6G communication system for supporting higher data transmission rates. According to an embodiment disclosed herein, provided are a method and device for configuring an interference measurement resource for effective channel state measurement in a wireless communication system.

### TECHNICAL FIELD

The disclosure relates to a method and a device for measuring interference in a wireless communication system.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In addition, improved methods for channel state reporting are being studied.

### DISCLOSURE

### Technical Problem

Disclosed embodiments are to provide a method and a device for reporting channel state information in a wireless communication system.

### Technical Solution

The disclosure to achieve the tasks above relates to a method performed by a terminal of a communication system, the method including: receiving channel state information (CSI) reporting configuration information from a base station, wherein the CSI reporting configuration information includes information on a channel measurement resource and information on an interference measurement resource; based on the CSI reporting configuration information, acquiring CSI by measuring a channel in the channel measurement resource and measuring interference in the interference measurement resource; and reporting the acquired CSI to the base station, wherein the interference measurement resource includes at least one of eight consecutive subcarriers on one orthogonal frequency division multiplexing (OFDM) symbol or eight consecutive symbols on one subcarrier.

In addition, a method performed by a base station of a communication system includes: transmitting channel state information (CSI) reporting configuration information to a terminal, wherein the CSI reporting configuration information includes information on a channel measurement resource and information on an interference measurement resource; and receiving CSI from the terminal, wherein the CSI is acquired by measuring a channel in the channel measurement resource and measuring interference in the inference measurement resource, and the interference measurement resource includes at least one of eight consecutive subcarriers on one orthogonal frequency division multiplexing (OFDM) symbol or eight consecutive symbols on one subcarrier.

In addition, a terminal of a communication system includes a transceiver, and a controller configured to perform control to: receive channel state information (CSI) reporting configuration information from a base station, wherein the CSI reporting configuration information includes information on a channel measurement resource and information on an interference measurement resource; based on the CSI reporting configuration information, acquire CSI by measuring a channel in the channel measurement resource and measuring interference in the interference measurement resource; and report the acquired CSI to the base station, wherein the interference measurement resource includes at least one of eight consecutive subcarriers on one orthogonal frequency division multiplexing (OFDM) symbol or eight consecutive symbols on one subcarrier.

In addition, a base station of a communication system includes a transceiver, and a controller configured to perform control to: transmit channel state information (CSI) reporting configuration information to a terminal, wherein the CSI reporting configuration information includes information on a channel measurement resource and information on an interference measurement resource; and receive CSI from the terminal, wherein the CSI is acquired by measuring a channel in the channel measurement resource and measuring interference in the inference measurement resource, and the interference measurement resource includes at least one of eight consecutive subcarriers on one orthogonal frequency division multiplexing (OFDM) symbol or eight consecutive symbols on one subcarrier.

### Advantageous Effects

According to disclosed embodiments, a communication method and device, in which a terminal effectively measures a channel state and feeds back channel state information to a base station in a wireless communication system, can be provided.

### DESCRIPTION OF DRAWINGS

FIG. 1 illustrates an example of a basic structure of a time-frequency domain which is a radio resource domain used to transmit data or control channels in a 5G system.

FIG. 2 illustrates an example of a slot structure used in a 5G communication system.

FIG. 3 illustrates an example of a bandwidth part (BWP) configuration in a 5G communication system.

FIG. 4 illustrates an example of a control resource set used to transmit a downlink control channel in a 5G communication system.

FIG. 5 illustrates an example of a structure of a downlink control channel in a 5G communication system.

FIG. 6 is a diagram illustrating an example of a method of configuring uplink and downlink resources in the 5G communication system.

FIG. 7 is a diagram illustrating an example of an aperiodic CSI reporting method.

FIG. 8 is a diagram illustrating an example of two patterns of interference measurement resources according to the disclosure.

FIG. 9 is a diagram illustrating an example of new patterns of interference measurement resources according to the disclosure.

FIG. 10 is a diagram illustrating an example of new patterns of interference measurement resources according to the disclosure.

FIG. 11A is a diagram illustrating an example of an operation performed by a base station according to the disclosure.

FIG. 11B is a diagram illustrating an example of an operation performed by a UE according to an example of the disclosure.

FIG. 12 is a block diagram illustrating an example of a structure of a UE according to the disclosure.

FIG. 13 is a block diagram illustrating an example of a structure of a base station according to the disclosure.

### MODE FOR INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

Hereinafter, a frame structure of a 5G system will be described in more detail with reference to the accompanying drawings.

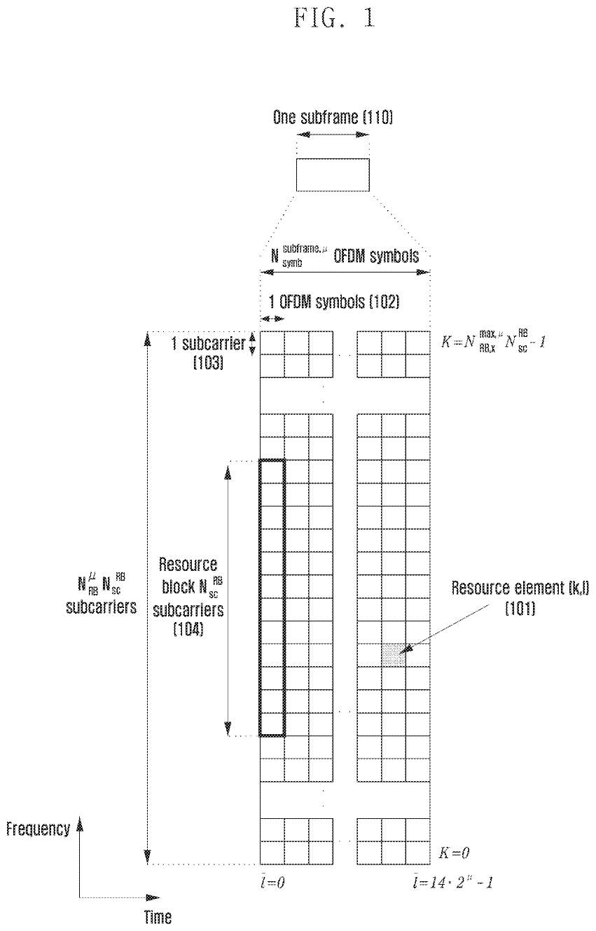

FIG. 1 illustrates an example of a basic structure of a time-frequency domain which is a radio resource domain used to transmit data or control channels in a 5G system.

Referring to FIG. 1, the horizontal axis represents a time domain, and the vertical axis represents a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain,

$${N}_{SC}^{RB}$$

(for example, 12) consecutive REs may constitute one resource block (RB) 104.

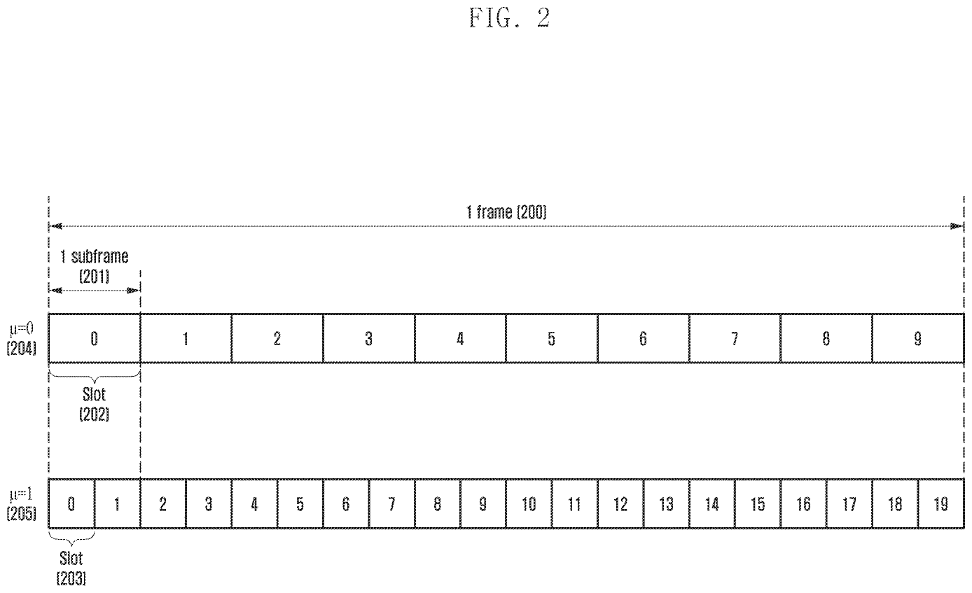

FIG. 2 illustrates an example of a slot structure used in a 5G communication system.

Referring to FIG. 2, an example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{symb}^{slot} = 14 ) .$$

One subframe 201 may include one or multiple slots 202 and 203, and the number of slots 202 and 203 per one subframe 201 may vary depending on configuration values μ for the subcarrier spacing 204 or 205. The example of FIG. 2 shows the case of μ=0 (2-04) and the case of μ=1 (2-05) as a configuration value for a subcarrier spacing. In the case of μ=0 (204), one subframe 201 may include one slot 202, and in the case of μ=1 (205), one subframe 201 may include two slots 203. That is, the number of slots per one subframe

$${N}_{slot}^{subframe , μ}$$

may differ depending on the subcarrier spacing configuration value u, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration μ as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, a bandwidth part (BWP) configuration in a 5G communication system will be described in detail with reference to the accompanying drawings.

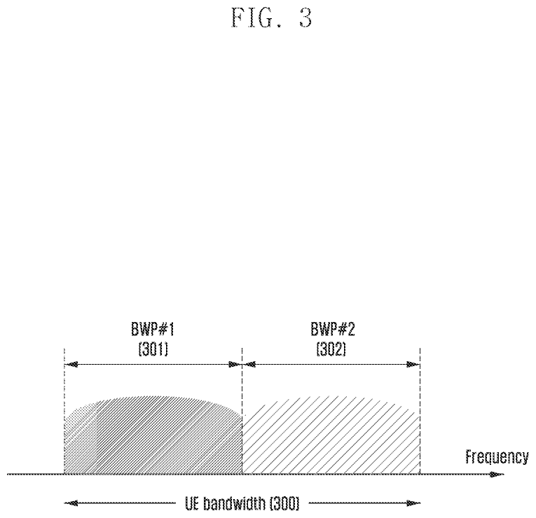

FIG. 3 illustrates an example of a BWP configuration in a 5G communication system.

Referring to FIG. 3, FIG. 3 illustrates an example in which a UE bandwidth 300 is configured to include two bandwidth parts, that is, BWP #1 301 and BWP #2 302. A base station may configure one or multiple bandwidth parts for a UE, and may configure the following pieces of information with regard to each bandwidth part as given in Table 2 below.

TABLE 2

| | |
|---|---|
| BWP ::= | SEQUENCE |

| | |
|---|---|
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Of course, the BWP configuration is not limited to the above example, and in addition to the above configuration information, various parameters related to the BWP may be configured for the UE. The base station may transmit the configuration information to the UE through upper layer signaling, for example, radio resource control (RRC) signaling. One configured BWP or at least one of multiple configured BWPs may be activated. Whether or not the configured BWP is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered to correspond to identity (ID) 0.

The base station may notify the UE of configuration information, such as frequency allocation information, time allocation information, and numerology, regarding control resource set #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial BWP for initial access. In this case, the identity (ID) of the initial BWP may be regarded as 0.

The UE may receive, through the configured initial BWP, a physical downlink shared channel (PDSCH) through which an SIB is transmitted. The initial BWP may be used not only for the purpose of receiving the SIB, but also for other system information (OSI), paging, random access, or the like.

The BWP-related configuration supported by the 5G system may be used for various purposes.

According to an embodiment, if the bandwidth supported by the UE is smaller than the system bandwidth, this may be supported through the BWP configuration. For example, the base station may configure the frequency location of the BWP for the UE, so that the UE can transmit/receive data at a specific frequency location within the system bandwidth.

In addition, according to an embodiment, the base station may configure multiple BWPs for the UE for the purpose of supporting different numerologies. For example, in order to support a UE's data transmission/reception using both a subcarrier spacing of 15 kHz and a subcarrier spacing of 30 kHz, two BWPs may be configured as subcarrier spacings of 15 kHz and 30 kHz, respectively. Different BWPs may be subjected to frequency division multiplexing (FDM), and if data is to be transmitted/received at a specific subcarrier spacing, the BWP configured as the corresponding subcarrier spacing may be activated.

In addition, according to an embodiment, the base station may configure BWPs having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a BWP of a relatively small bandwidth (for example, a BWP of 20 MHz) for the UE. The UE may perform a monitoring operation in the 20 MHz bandwidth part in the absence of traffic, and may transmit/receive data with the 100 MHz BWP as instructed by the base station if data has occurred.

If one or more BWPs are configured for the UE, the base station may indicate, to the UE, to change the BWPs by using a BWP indicator field within DCI. As an example, if the currently activated BWP of the UE is BWP #1 301 in FIG. 3, the base station may indicate BWP #2 302 with a BWP indicator within DCI, and the UE may change the BWP to BWP #2 302 indicated by the BWP indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given below, for example.

TABLE 3

BWP switch delay TBWP (slots)

| μ | NR Slot length (ms) | Type 1^{Note 1} | Type 2^{Note 1} |
|---|---|---|---|
| 0 | 1 | 1 | 1 |
| 1 | 0.5 | 2 | 5 |
| 2 | 0.25 | 3 | 9 |
| 3 | 0.125 | 6 | 18 |

^{Note 1}:
Depends on UE capability.
^{Note 2}:
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. According to an embodiment, if the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K=1).

Next, synchronization signal/physical broadcast channel (SS/PBCH) blocks in a 5G wireless communication system will be described.

An SS/PBCH block may refer to a physical layer channel block including a primary synchronization signal (PSS), a secondary synchronization signal (SSS), and a PBCH. Details thereof may be as follows.
PSS: a signal which becomes a reference of downlink time/frequency synchronization, and provides partial information of a cell ID.
SSS: becomes a reference of downlink time/frequency synchronization, and provides remaining cell ID information not provided by the PSS. Additionally, the SSS may serve as a reference signal for PBCH demodulation of a PBCH.
PBCH: provides an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and from this, control resource set #0 (which may correspond to a control resource set having a control resource set index of 0) may be configured for the UE. The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0.

The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

Next, downlink control information (DCI) in a 5G communication system will be described in detail.

In a 5G system, scheduling information regarding uplink data (or PUSCH) or downlink data (or PDSCH) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

According to an embodiment, the DCI may be subjected to channel coding and modulation processes and then transmitted through a physical downlink control channel (PDCCH). A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI), modulation coding scheme C-RNTI (MCS-C-RNTI), or configured scheduling RNTI (CS-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information, for example.

```
TABLE 4
- Identifier for DCI formats −1 bit
  - The value of this bit field is always set to 0, indicating an UL DCI format
- Frequency domain resource assignment
    $⌈ {log}_{2} ( {N}_{RB}^{BL , BWP} ( {N}_{RB}^{UL , BWP} + 1 ) / 2 ) ⌉ bits where {N}_{RB}^{UL , BWP} is defined in subclause 7.3 \text{.1} \text{.0}$
  - For PUSCH hopping with resource allocation type 1:
      - N_{UL}_loop MSB bits are used to indicate the frequency offset according to Subclause 6.3 of [6,
        TS 38.214], where N_{UL}_loop = 1 if the higher layer parameter frequencyHoppingOffsetLists
        contains two offset values and N_{UL}_loop = 2 if the higher layer parameter
        frequencyHoppingOffsetLists contains four offset values
      -  $⌈ {log}_{2} ( {N}_{RB}^{BL , BWP} ( {N}_{RB}^{UL , BWP} + 1 ) / 2 ) ⌉ - {N}_{UL , hop} bits provides the frequency domain resource$
        allocation according to Subclause 6.1.2.2.2 of [6, TS 38.214]
  - For non-PUSCH hopping with resource allocation type 1:
      -  $⌈ {log}_{2} ( {N}_{RB}^{BL , BWP} ( {N}_{RB}^{UL , BWP} + 1 ) / 2 ) ⌉ bits provides the frequency domain resource allocation$
        according to Subclause 6.1.2.2.2 of [6, TS 38,214]
- Time domain resource assignment  −4 bits as defined in Subclause
  6.1.2.1 of [6, TS 38.214]
- Frequency hopping flag −1 bit according to Table 7.3.1.1.1-3, as defined
  in Subclause 6.3 of [6, TS 38.214]
- Modulation and coding scheme −5 bits as defined in Subclause 6.1.4.1 of
  [6, TS 38.214]
- New data indicator −1 bit
- Redundancy version −2 bits as defined in Table 7.3.1.1.1-2
- HARQ process number −4 bits
- TPC command for scheduled PUSCH −
  2 bits as defined in Subclause 7.1.1 of [5, TS 38.213]
- Padding bits, if required.
- UL/SUL indicator (Supplementary UL indicator) −1 bit for UEs
  configured with supplementaryUplink in ServingCellConfig in the cell as defined in Table
  7.3.1.1.1-1 and the number of bits for DCI format 1_0 before padding is larger than the number of
  bits for DCI format 0_0 before padding: 0 bit otherwise. The UL/SUL indicator, if present, locates
  in the last bit position of DCI format 0_0, after the padding bit(s).
  - If the UL/SUL indicator is present in DCI format 0_0 and the higher layer parameter pusch-
      Config is not configured on both UL and SUL the UE ignores the UIL/SUL indicator field in
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information, for example.

```
TABLE 5
- Identifier for DCI formats −1 bit
  - The value of this bit field is always set to 0, indicating an UL DCI format
- Carrier indicator  −0 or 3 bits, as defined in Subclause 10.1 of [5, TS38.213].
- UL/SUL indicator  (Supplementary UL indicator) −0 bit for UEs
  not configured with supplementaryUplink in ServingCellConfig in the cell or UEs configured with
  supplementaryUplink in ServingCellConfig in the cell but only PUCCH carrier in the cell is
  configured for PUSCH transmission; otherwise, 1 bit as defined in Table 7.3.1.1.1-1.
- Bandwidth part indicator  −0, 1 or 2 bits as determined by the number of
  UL BWPs n_{BWP,RRC} configured by higher layers, excluding the initial UL bandwidth part. The
  bitwidth for this field is determined as ┌log₂ (n_{BWP})┐ bits, where
  - n_{BWP} = n_{BWP,RRC} +1 if n_{BWP,RRC} ≤3, in which case the bandwidth part indicator is equivalent to
      the ascending order of the higher layer parameter BWP-Id;
  - otherwise n_{BWP} = n_{BWP,RRC}, in which case the bandwidth part indicator is defined in Table
      7.3.1.1.2-1;
  If a UE does not support active BWP change via DCI, the UE ignores this bit field.
- Frequency domain resource assignment − number of bits
    $determined by the following , where {N}_{RB}^{UL , BWP} is the size of the active UL bandwidth part :$
  - N_{RBG} bits if only resource allocation type 0 is configured, where N_{RBG} is defined in
      Subclause 6.1.2.2.1 of [6, TS 38.214],
    $⌈ {log}_{2} ( {N}_{RB}^{UL , BWP} ( {N}_{RB}^{UL , BWP} + 1 ) / 2 ) ⌉ bits if only resources allocation type 1 is configured , or$
      $max ( ⌈ {log}_{2} ( {N}_{RB}^{UL , BWP} ( {N}_{RB}^{UL , BWP} + 1 ) / 2 ) ⌉ , {N}_{RBG} ) + bits if both resource allocation type 0 and 1$
      are configured.
  - If both resource allocation type 0 and 1 are configured, the MSB bit is used to indicate resource
      allocation type 0 or resource allocation type 1, where the bit value of 0 indicates resource
      allocation type 0 and the bit value of 1 indicates resource allocation type 1.
  - For resource allocation type 0, the N_{RBG} LSBs provide the resource allocation as defined in
      Subclause 6,1.2.2.1 of [6, TS 38.214).
    $For resource allocation type 1 , the ⌈ {log}_{2} ( {N}_{RB}^{UL , BWP} ( {N}_{RB}^{UL , BWP} + 1 ) / 2 ) ⌉ LSBs provide the resource$
      allocation as follows:
      - For PUSCH hopping with resource allocation type 1:
      - N [symbol]    MSB bits are used to indicate the frequency offset according to Subclause 6.3 of
        [6, TS 38.214], where N [symbol]    =1 if the higher layer parameter
        frequencyHoppingOffsetLists contains two offset values and N [symbol]   = 2 if the higher
        layer parameter frequencyHoppingOffsetLists contains four offset values
    $⌈ {log}_{2} ( {N}_{RB}^{UL , BWP} ( {N}_{RB}^{UL , BWP} + 1 ) / 2 ) ⌉ - {N}_{UL , hop} bits provides the frequency domain resource$
        allocation according to Subclause 6.1.2.2.2 of [6, TS 38.214]
  - For non-PUSCH hopping with resource allocation type 1:
    $⌈ {log}_{2} ( {N}_{RB}^{BL , BWP} ( {N}_{RB}^{UL , BWP} + 1 ) / 2 ) ⌉ bits provides the frequency domain resources allocation$
        according to Subclause 6.1.2.2.2 of [6, TS 38.214]
  If “Bandwidth part indicator” field indicates a bandwidth part other than the active bandwidth
  part and if both resource allocation type 0 and 1 are configured for the indicated bandwidth
  part, the UE assumes resource allocation type 0 for the indicated bandwidth part if the bitwidth
  of the “Frequency domain resource assignment” field of the active bandwidth part is smaller
  than the bitwidth of the “Frequency domain resource assignment” field of the indicated
  bandwidth part.
- Time domain resource assignment −0, 1, 2, 3, or 4 bits as defined in
Subclause 6.1.2.1 of [6, TS38.214]. The bitwidth for this field is determined as ┌log₂(I)┐ bits,
where I is the number of entries in the higher layer parameter pusch-TimeDomainAllocationList if
the higher layer parameter is configured; otherwise I is the number of entries in the default table.
- Frequency hopping flag −0 or 1 bit:
  - 0 bit if only resource allocation type 0 is configured or if the higher layer parameter
      frequencyHopping is not configured;
  - 1 bit according to Table 7.3.1.1.1-3 otherwise, only applicable to resource allocation type 1, as
    defined in Subclause 6.3 of [6, TS 38.214].
- Modulation and coding scheme −5 bits as defined in Subclause 6.1.4.1 of
  [6, TS 38.214]
- New data indicator −1 bit
- Redundancy version −2 bits as defined in Table 7.3.1.1.1-2
- HARQ process number −4 bits
- 1^{st} downlink assignment index −1 or 2 bits:
  - 1 bit for semi-static HARQ-ACK codebook;
  - 2 bits for dynamic HARQ-ACK codebook.
- 2^{nd} downlink assignment index −0 or 2 bits:
  - 2 bits for dynamic HARQ-ACK codebook with two HARQ-ACK sub-codebooks;
  - 0 bit otherwise,
  - TPC commaand for scheduled PUSCH −
  2 bits as defined in Subclause 7.1.1 of [5, TS38.213]
- SRS resource indicator −
  $⌈ {log}_{2} ( {\sum }_{k = 1}^{min ⌈ {L}_{max} , {N}_{SRS} ⌉} ( \begin{matrix}{N}_{SRS} \\ k\end{matrix} ) ) ⌉ or ⌈ {log}_{2} ( {N}_{SRS} ) ⌉ bits , where {N}_{SRS} is the number of configured SRS$
  resources in the SRS resource set associated with the higher layer parameter usage of value
  ‘codeBook’ or ‘nonCodeBook’,
  $⌈ {log}_{2} ( {\sum }_{k = 1}^{min ⌈ {L}_{max} , {N}_{SRS} ⌉} ( \begin{matrix}{N}_{SRS} \\ k\end{matrix} ) ) ⌉ bits according to Tables 7.3 \text{.1} \text{.1} \text{.2} - 28 / 29 / 30 / 31 if the higher layer$
    parameter txConfig = nonCodebook, where N_{SRS} is the number of configured SRS resources
    in the SRS resource set associated with the higher layer parameter usage of value
    ‘nonCodeBook’ and
    - if UE supports operation with maxMIMO-Layers and the higher layer parameter maxMIMO-
        Layers of PUSCH-ServingCellConfig of the serving cell is configured, Lₘₐₓ is given by that
        parameter
    - otherwise, Lₘₐₓ is given by the maximum number of layers for PUSCH supported by the UE
        for the serving cell for non-codebook based operation.
- ┌log₂ (N_{SRS})┐ bits according to Tables 7.3.1.1.2-32 if the higher layer parameter txConfig =
    codebook, where N_{SRS} is the number of configured SRS resources in the SRS resource set
    associated with the higher layer parameter usage of value ‘codeBook’.
- Precoding information and number of layers −number of bits
  determined by the following:
- 0 bits if the higher layer parameter txConfig = nonCodeBook;
- 0 bits for 1 antenna port and if the higher layer parameter txConfig = codebook;
- 4, 5, or 6 bits according to Table 7.3.1.1.2-2 for 4 antenna ports, if txConfig = codebook, and
  according to whether transform precoder is enabled or disabled, and the values of higher layer
  parameters maxRank, and codebookSubset;
- 2, 4, or 5 bits according to Table 7.3.1.1.2-3 for 4 antenna ports, if txConfig = codebook, and
  according to whether transform precoder is enabled or disabled, and the values of higher layer
  parameters maxRank, and codebookSubset;
- 2 or 4 bits according to Table7.3.1.1.2-4 for 2 antenna ports, if txConfig = codebook, and
  according to whether transform precoder is enabled or disabled, and the values of higher layer
  parameters maxRank and codebookSubset;
- 1 or 3 bits according to Table7.3.1.1.2-5 for 2 antenna ports, if txConfig = codebook, and
  according to whether transform precoder is enabled or disabled, and the values of higher layer
  parameters maxRank and codebookSubset.
- Antenna ports −number of bits determined by the following
  - 2 bits as defined by Tables 7.3.1.1.2-6, if transform precoder is enabled, dmrs-Type=1, and
      maxLength=1;
  - 4 bits as defined by Tables 7.3.1.1.2-7, if transform precoder is enabled, dmrs-Type=1, and
      maxLength=2;
  - 3 bits as defined by Tables 7.3.1.1.2-8/9/10/11, if transform precoder is disabled, dmrs-Type=1,
      and maxLength=1, and the value of rank is determined according to the SRS resource indicator
      field if the higher layer parameter txConfig = nonCodebook and according to the Precoding
      information and number of layers field if the higher layer parameter txConfig = codebook;
  - 4 bits as defined by Tables 7.3.1.1.2-12/13/14/15, if transform precoder is disabled, dmrs-
      Type=1, and maxLength=2, and the value of rank is determined according to the SRS resource
      indicator field if the higher layer parameter txConfig = nonCodebook and according to the
      Precoding information and number of layers field if the higher layer parameter txConfig =
      codebook;
  - 4 bits as defined by Tables 7.3.1.1.2-16/17/18/19, if transform precoder is disabled, dmrs-
      Type=2, and maxLength=1, and the value of rank is determined according to the SRS resource
      indicator field if the higher layer parameter txConfig = nonCodebook and according to the
      Precoding information and number of layers field if the higher layer parameter txConfig =
      codebook;
  - 5 bits as defined by Tables 7.3.1.1.2-20/21/22/23, if transform precoder is disabled, dmrs-
      Type=2, and maxLength=2, and the value of rank is determined according to the SRS resource
      indicator field if the higher layer parameter txConfig = nonCodehook and according to the
      Precoding information and number of layers field if the higher layer parameter txConfig =
      codebook.
where the number of CDM groups without data of values 1, 2, and 3 in Tables 7.3.1.1.2-6 to
7.3.1.1.2-23 refers to CDM groups {0}, {0,1}, and {0, 1, 2} respectively.
If a UE is configured with both dmrs-UplinkForPUSCH-MappingTypeA and dmrs-
UplinkForPUSCH-MappingTypeB, the bitwidth of this field equals max{x_{A},x_{B}} where x_{A} is
the “Antenna ports” bitwidth derived according to dmrs-UplinkForPUSCH-MappingTypeA and
x_{B} is the “Antenna ports” bitwidth derived according to dmrs-UplinkForPUSCH-MappingTypeB.
A number of |x_{A} − x_{B}| zeros are padded in the MSB of this field, if the mapping type of the
PUSCH corresponds to the smaller value of x_{A} and x_{B}.
- SRS request −2 bits as defined by Table 7.3.1.1.2-24 for UEs not configured with
supplementaryUplink in ServingCellConfig in the cell; 3 bits for UEs configured with
supplementaryUplink in ServingCellConfig in the cell where the first bit is the non-SUL/SUL
indicator as defined in Table 7.3.1.1.1-1 and the second and third bits are defined by Table
7.3.1.1.2-24. This bit field may also indicate the associated CSI-RS according to Subclause 6.1.1.2
of [6, TS 38.214].
- CSI request  −0, 1, 2, 3, 4, 5, or 6 bits
  determined by higher layer parameter reportTriggerSize.
- CBG transmission information (CBGTI)
      −0 bit if higher layer parameter codeBlockGroupTransmission for PDSCH is not
      configured, otherwise, 2, 4, 6, or 8 bits determined by higher layer parameter
      maxCodeBlockGroupsPerTransportBlock for PUSCH.
- PTRS-DMRS association. - number of bits determined as follows
  - 0 bit if PTRS-UplinkConfig is not configured and transform precoder is disabled, or if
      transform precoder is enabled, or if maxRank=1;
  - 2 bits otherwise, where Table 7.3.1.1.2-25 and 7.3.1.1.2-26 are used to indicate the association
      between PTRS port(s) and DMRS port(s) for transmission of one PT-RS port and two PT-RS
      ports respectively, and the DMRS ports are indicated by the Antenna ports field.
  -If “Bandwidth part indicator” field indicates a bandwidth part other than the active bandwidth part
    and the “PTRS-DMRS association” field is present for the indicated bandwidth part but not
    present for the active bandwidth part, the UE assumes the “PTRS-DMRS association” field is not
    present for the indicated bandwidth part.
- beta_offset indicator −0 if the higher layer parameter betaOffsets =
    semiStatic; otherwise 2 bits as defined by Table 9.3-3 in [5, TS 38.213].
- DMRS sequence initialization  −0 bit if transform precoder is
    enabled; 1 bit if transform precoder is disabled.
- UL-SCH indicator −1 bit. A value of “1” indicates
- UL-SCH shall be transmitted on the PUSCH and a value of “0” indicates UL- SCH shall not be
    transmitted on the PUSCH, Except for DCI format 0_1 with CRC scrambled by SP-CSI-RNTI, a
    UE is not expected to receive a DCI format 0_1 with UL-SCH indicator of “0” and CSI request of
    all zero(s). [symbol]
indicates data missing or illegible when filed
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

```
TABLE 6
- Identifier for DCI formats −1 bits
  - The value of this bit field is always set to 1, indicating a DL DCI format
- Frequency domain resource assignment −
  $⌈ {log}_{2} ( {N}_{RB}^{DL , BWP} ( {N}_{RB}^{DL , BWP} + 1 ) / 2 ) ⌉ bits where {N}_{RB}^{DL , BWP} is given by subclause 7.3 \text{.1} \text{.0}$
If the CRC of the DCI format 1_0 is scrambled by C-RNTI and the “Frequency domain resource
assignment” field are of all ones, the DCI format 1_0 is for random access procedure initiated by a
PDCCH order, with all remaining fields set as follows:
- Random Access Preamble index −6 bits according to ra-
  PreambleIndex in Subclause 5.1.2 of [8, TS38.321]
- UL/SUL indicator −1 bit. If the
  value of the “Random Access Preamble index” is not all zeros and if the UE is configured with
  supplementaryUplink in ServingCellConfig in the cell, this field indicates which UL carrier in the
  cell to transmit the PRACH according to Table 7.3.1.1.1-1; otherwise, this field is reserved
- SS/PBCH index −6 bits. If the value of the “Random Access Preamble index” is not all
  zeros, this field indicates the SS/PBCH that shall be used to determine the RACH occasion for the
  PRACH transmission; otherwise, this field is reserved.
- PRACH Mask index
          - 4 bits. If the value of the “Random Access Preamble index” is not all zeros, this field
  indicates the RACH occasion associated with the SS/PBCH indicated by “SS/PBCH index” for the
  PRACH transmission, according to Subclause 5.1.1 of [8, TS38.321]; otherwise, this field is
  reserved
- Reserved bits −10 bits
Otherwise, all remaining fields are set as follows:
- Time domain resource assignment −4 bits as defined in Subclause
  5.1.2.1 of [6, TS 38.214]
- VRB-to-PRB mapping −1 bit according to Table 7.3.1.2.2-5
- Modulation and coding scheme −5 bits as defined in Subclause 5.1.3 of [6, TS
  38.214]
- New data indicator −1 bit
- Redundancy version −2 bits as defined in Table 7.3.1.1.1-2
- HARQ process number −4 bits
- Downlink assignment index −2 bits as defined in Subclause 9.1.3 of
  [5, TS 38.213], as counter DAI
- TPC command for scheduled PUCCH —
  2 bits as defined in Subclause 7.2.1 of [5, TS 38.213]
- PUCCH resource indicator  −3 bits as defined in Subclause 9.2.3 of [5,
  TS 38.213]
- PDSCH-to-HARQ_feedback timing indicator
  bits as defined in Subclause 9.2.3 of [5, TS38.213]
```

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information, for example.

```
TABLE 7
- Identifier for DCI formats −1 bits
  - The value of this bit field is always set to 1, indicating a DL DCI format
- Carrier indicator −0 or 3 bits as defined in Subclause 10.1 of [5, TS 38.213].
- Bandwidth part indicator −0, 1 or 2 bits as determined by the number of
  DL BWPs n_{BWPRRC} configured by higher layers, excluding the initial DL bandwidth part. The
  bitwidth for this field is determined as ┌log₂(n_{BWP})┐ bits, where
  - n_{BWP} = n_{BWP,RRC} + 1 if n_{BWP,RRC} ≤ 3, in which case the bandwidth part indicator is equivalent to
      the ascending order of the higher layer parameter BWP-Id;
  - otherwise n_{BWP} = n_{BWP,RRC}, in which case the bandwidth part indicator is defined in Table
      7.3.1.1.2-1;
  If a UE does not support active BWP change via DCI, the UE ignores this bit field.
- Frequency domain resource assignment −number of bits
  $determined by the following , where {N}_{RB}^{DL , BWP} is the size of the active DL bandwidth part :$
  - N_{RBG} bits if only resource allocation type 0 is configured, where N_{RBG} is defined in
      Subclause 5.1.2.2.1 of [6, TS38.214],
  - $⌈ {log}_{2} ( {N}_{RB}^{DL , BWP} ( {N}_{RB}^{DL , BWP} + 1 ) / 2 ) ⌉ bits if only resource allocation type 1 is configured , or$
  $max ( ⌈ {log}_{2} ( {N}_{RB}^{DL , BWP} ( {N}_{RB}^{DL , BWP} + 1 ) / 2 ) ⌉ , {N}_{RBG} ) + 1 bits if both resource allocation type 0 and 1$
      are configured.
  - If both resource allocation type 0 and 1 are configured, the MSB bit is used to indicate resource
      allocation type 0 or resource allocation type 1, where the bit value of 0 indicates resource
      allocation type 0 and the bit value of 1 indicates resource allocation type 1.
  - For resource allocation type 0, the N_{RBG} LSBs provide the resource allocation as defined in
      Subclause 5.1.2.2.1 of [6, TS 38.214].
    -  $For resource allocation type 1 , the ⌈ {log}_{2} ( {N}_{RB}^{DL , BWP} ( {N}_{RB}^{DL , BWP} + 1 ) / 2 ) ⌉ LSBs provide the resource$
      allocation as defined in Subclause 5.1.2.2.2 of [6, TS 38.214]
  If “Bandwidth part indicator” field indicates a bandwidth part other than the active bandwidth part
  and if both resource allocation type 0 and 1 are configured for the indicated bandwidth part, the
  UE assumes resource allocation type 0 for the indicated bandwidth part if the bitwidth of the
  “Frequency domain resource assignment” field of the active bandwidth part is smaller than the
  bitwidth of the “Frequency domain resource assignment” field of the indicated bandwidth part.
- Time domain resource assignment −0, 1, 2, 3, or 4 bits as defined in
  Subclause 5.1.2.1 of [6, TS 38.214]. The bitwidth for this field is determined as ┌log₂(I)┐ bits,
  where I is the number of entries in the higher layer parameter pdsch-TimeDomainAllocationList if
  the higher layer parameter is configured; otherwise I is the number of entries in the default table.
- VRB-to-PRB mapping −0 or 1 bit:
  - 0 bit if only resource allocation type 0 is configured or if interleaved VRB-to-PRB mapping is
      not configured by high layers;
  - 1 bit according to Table 7.3.1.2.2-5 otherwise, only applicable to resource allocation type 1, as
      defined in Subclause 7.3.1.6 of [4, TS 38.211].
- PRB bundling size indicator −0 bit if the higher layer parameter
  prb-BundlingType is not configured or is set to ‘static’, or 1 bit if the higher layer parameter prb-
  BundlingType is set to ‘dynamic’ according to Subclause 5.1.2.3 of [6, TS 38.214].
- Rate matching indicator −0, 1, or 2 bits according to higher layer
  parameters rateMatchPatternGroup1 and rateMatchPatternGroup2, where the MSB is used to
  indicate rateMatchPatternGroup1 and the LSB is used to indicate rateMatchPatternGroup2 when
  there are two groups.
- ZP CSI-RS trigger  −0, 1, or 2 bits as defined in
  Subclause 5.1.4.2 of [6, TS 38.214]. The bitwidth for this field is determined as ┌log₂(n_{ZP} +1)┐
  bits, where n_{ZP} is the number of aperiodic ZP CSI-RS resource sets configured by higher layer.
For transport block 1:
  - Modulation and coding scheme  −5 bits as defined in Subclause 5.1.3.1
      of [6, TS 38.214]
  - New data indicator −1 bit
  - Redundancy version −2 bits as defined in Table 7.3.1.1.1-2
For transport block 2 (only present if maxNrofCodeWordsScheduledByDCI equals 2) :
  - Modulation and coding scheme −5 bits as defined in Subclause 5.1.3.1
      of [6, TS 38.214]
  - New data indicator −1 bit
  - Redundancy version  −2 bits as defined in Table 7.3.1.1.1-2
  If “Bandwidth part indicator” field indicates a bandwidth part other than the active bandwidth part
  and the value of maxNrofCodeWordsScheduledByDCI for the indicated bandwidth part equals 2
  and the value of maxNrofCodeWordsScheduledByDCI for the active bandwidth part equals 1, the
  UE assumes zeros are padded when interpreting the “Modulation and coding scheme”, “New data
  indicator”, and “Redundancy version” fields of transport block 2 according to Subclause 12 of [5,
  TS38.213], and the UE ignores the “Modulation and coding scheme”, “New data indicator″, and
  “Redundancy version” fields of transport block 2 for the indicated bandwidth part,
  - HARQ process number −4 bits
  - Downlink assignment index −number of bits as defined in the
  following
  - 4 bits if more than one serving cell are configured in the DL and the higher layer parameter
      pdsch-HARQ-ACK-Codebook=dynamic, where the 2 MSB bits are the counter DAI and the 2
      LSB bits are the total DAI;
  - 2 bits if only one serving cell is configured in the DL and the higher layer parameter pdsch-
      HARQ-ACK-Codebook=dynamic, where the 2 bits are the counter DAI;
  - 0 bits otherwise.
- TPC command for scheduled PUCCH −
  2 bits as defined in Subclause 7.2.1 of [5, TS 38.213]
- PUCCH resource indicator −3 bits as defined in Subclause 9.2.3 of [5,
  TS 38.213]
- PDSCH-to-HARQ feedback timing indicator −0, 1, 2, or 3
  bits as defined in Subclause 9.2.3 of [5, TS 38.213]. The bitwidth for this field is determined as
  ┌log₂(I)┐ bits, where I is the number of entries in the higher layer parameter dl-DataToUL-ACK.
- Antenna port(s) −4, 5, or 6 bits as defined by Tables 7.3.1.2.2-1/2/3/4, where the
  number of CDM groups without data of values 1, 2, and 3 refers to CDM groups {0}, {0,1}, and
  {0, 1,2} respectively. The antenna ports {p_{0,... ,}p₀₋₄} shall be determined according to the ordering
  of DMRS port(s) given by Tables 7.3.1.2.2-1/2/3/4.
  If a UE is configured with both dmrs-DownlinkForPDSCH-MappingTypeA and dmrs-
  DownlinkForPDSCH-MappingTypeB, the bitwidth of this field equals max (x_{A},x_{B}, where x_{A} is
  the “Antenna ports” bitwidth derived according to dmrs-DownlinkForPDSCH-MappingTypeA and
  x_{B} is the “Antenna ports” bitwidth derived according to dmrs-DownlinkForPDSCH-
  MappingTypeB. A number of |x_{A} − x_{B}| zeros are padded in the MSB of this field, if the mapping
  type of the PDSCH corresponds to the smaller value of x_{A} and x_{B}.
- Transmission configuration indication −0 bit if higher layer parameter tci-
  PresentInDCI is not enabled; otherwise 3 bits as defined in Subclause 5.1.5 of [6, TS38.214].
  If “Bandwidth part indicator” field indicates a bandwidth part other than the active bandwidth part.
  - if the higher layer parameter tci-PresentInDCI is not enabled for the CORESET used for the
      PDCCH carrying the DCI format 1_1.
  - the UE assumes tci-PresentInDCI is not enabled for all CORESETs in the indicated
      bandwidth part;
  - otherwise,
    - the UE assures tci-PresentInDCI is enabled for all CORESETs in the indicated bandwidth
        part.
- SRS request −2 bits as defined by Table 7.3.1.1.2-24 for UEs not configured with
  supplementaryUplink in ServingCellConfig in the cell; 3 bits for UEs configured with
  supplementaryUplink in ServingCellConfig in the cell where the first bit is the non-SUL/SUL
  indicator as defined in Table 7.3.1.1.1-1 and the second and third bits are defined by Table
  7.3.1.1.2-24. This bit field may also indicate the associated CSI-RS according to Subclause 6.1.1.2
  of [6, TS 38.214].
- CBG transmission information (CBFTI) −0 bit if higher layer
  parameter codeBlockGroup Transmission for PDSCH is not configured, otherwise, 2, 4, 6, or 8 bits
  as defined in Subclause 5.1.7 of [6, TS38.214], determined by the higher layer parameters
  maxCodeBlockGroupsPerTransportBlock and maxNrofCodeWordsScheduledByDCI for the
  PDSCH.
- CBG flushing out information (CBGFI) −1 bit if higher
  layer parameter codeBlockGroupFlushindicator is configured as “TRUE”, 0 bit otherwise.
- DMRS sequence initialization −1 bit.
```

Hereinafter, a time domain resource allocation method regarding a data channel in a 5G wireless communication system will be described.

A base station may configure a table for time domain resource allocation information regarding a PDSCH and a PUSCH for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 8 or Table 9 below may be transmitted from the base station to the UE.

TABLE 8

```
  PDSCH-TimeDomainResourceAllocationList information element
  PDSCH-TimeDomainResourceAllocationList ::= SEQUENCE (SIZE(1..
  maxNrofDL-Allocations)) OF PDSCH-TimeDomainResourceAllocation
  PDSCH-TimeDomainResourceAllocation ::= SEQUENCE {
      k0 INTEGER(0..32) OPTIONAL, -- Need S
      (PDCCH-to-PDSCH timing, slot unit)
      mappingType ENUMERATED {typeA, typeB},
    (PDSCH mapping type)
    startSymbolAndLength INTEGER (0..127)
    (start symbol and length of PDSCH)
}
```

```
TABLE 9
PUSCH-TimeDomainResourceAllocationList information element
PUSCH-TimeDomainResourceAllocationList ::= SEQUENCE (SIZE(1..
maxNrofUL-Allocations)) OF PUSCH-TimeDomainResourceAllocation
PUSCH-TimeDomainResourceAllocation ::= SEQUENCE {
  k2 INTEGER(0..32) OPTIONAL, -- Need S
    (PDCCH-to-PUSCH timing, slot unit)
    mappingType ENUMERATED {typeA, typeB},
    (PUSCH mapping type)
    startSymbolAndLength INTEGER (0..127)
    (start symbol and length of PUSCH)
}
```

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station. Hereinafter, a frequency domain resource allocation method for a data channel in the 5G wireless communication system will be described.

In the 5G wireless communication system, two types of resource allocation type 0 and resource allocation type 1 are supported as a method of indicating frequency domain resource allocation information for a PDSCH and a PUSCH.

### Resource Allocation Type 0

A notification of RB allocation information may be provided from a base station to a UE in the form of a bitmap for a resource block group (RBG). In this case, the RBG may include a set of consecutive virtual RBs (VRBs), and size P of the RBG may be determined based on a value configured as a higher-layer parameter (rbg-Size) and a BWP size value defined in the table below.

TABLE 10

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

A total number (N_{RBG}) of RBGs of bandwidth part i having a size of

$${N}_{BWP , i}^{size}$$

may be defined as follows.

$${N}_{RBG} = ⌈ ( {N}_{BWP , i}^{size} + ( {N}_{BWP , i}^{start} mod P ) ) / P ⌉ ,$$

where
the size of the first RBG is

$${RBG}_{0}^{size} = P - {N}_{BWP , i}^{start} mod P ,$$

and
the size of last RBG is

$${RBG}_{last}^{size} = ( {N}_{BWP , i}^{start} + {N}_{BWP , i}^{size} ) mod P$$

if

$$( {N}_{BWP , i}^{start} + {N}_{BWP , i}^{size} ) mod P > 0$$

and P, otherwise,
the size of all other RBGs is P.

Each bit of a bitmap having a size of N_{RBG} bits may correspond to each RBG. RBGs may be indexed in an ascending order of frequency starting from a lowest frequency position of BWP. With respect to N_{RBG} RBGs in BWP, RBG #0 to RBG #(N_{RBG-1}−1) may be mapped to bits of an RGB bitmap from a most significant bit (MSB) to a least significant bit (LSB). When a specific bit value in the bitmap is 1, the UE may determine that an RBG corresponding to the bit value has been assigned, and when the specific bit value in the bitmap is 0, the UE may determine that an RBG corresponding to the bit value has not been assigned.

### Resource Allocation Type 1

A notification of RB allocation information may be provided as information on start positions and lengths of consecutively allocated VRBs to the UE by the base station. In this case, interleaving or non-interleaving may be additionally applied to the consecutively allocated VRBs. A resource allocation field of resource allocation type 1 may include a resource indication value (RIV), and the RIV may include a start point (RBₛₜₐᵣₜ) of a VRB and a length (L_{RBs}) of consecutively allocated RBs. More specifically, an RIV in a BWP having a size of

$${N}_{BWP , i}^{s i z e}$$

may be defined as follows.

$$if ( {L}_{RBs} - 1 ) \leq ⌊ {N}_{BWP}^{size} / 2 ⌋ then$$

$$RIV = {N}_{B W P}^{size} ( {L}_{RBs} - 1 ) + R {B}_{start}$$

$$else$$

$$RIV = {N}_{B W P}^{size} ( {N}_{B W P}^{size} - {L}_{RBs} + 1 ) + ( {N}_{B W P}^{size} - 1 - R {B}_{s t a r t} )$$

where L_{RBs}≥1 and shall not exceed

$${N}_{B W P}^{s i z e} - R {B}_{start} .$$

The base station may configure a resource allocation type for the UE via higher-layer signaling (for example, higher-layer parameter resourceAllocation may be configured to be one of resourceAllocationType0, resourceAllocationType1, or dynamicSwitch). If the UE is configured with both resource allocation types 0 and 1 (or equally, higher-layer parameter resourceAllocation is configured to be dynamicSwitch), the base station may indicate whether the resource allocation type is resource allocation type 0 or resource allocation type 1 by using a bit corresponding to an MSB of a field indicating resource allocation in a DCI format indicating scheduling. In addition, based on the indicated resource allocation type, resource allocation information may be indicated via bits remaining after excluding the bit corresponding to the MSB, and based on this, the UE may interpret resource allocation field information of a DCI field. If one of resource allocation type 0 or resource allocation type 1 is configured for the UE (or equally, higher-layer parameter resourceAllocation is configured to be one value of resourceAllocationType0 or resourceAllocationType1), the field indicating resource allocation in the DCI format indicating scheduling may indicate resource allocation information according to the configured resource allocation type, and based on this, the UE may interpret the resource allocation field information of the DCI field.

Hereinafter, a specific description will be provided for a modulation and coding scheme (MCS) used in the 5G communication system.

In the 5G communication system, multiple MCS index tables are defined for PDSCH and PUSCH scheduling. An MCS table that is to be assumed by the UE among the multiple MCS tables may be configured or indicated via higher-layer signaling or L1 signaling from the base station to the UE or via an RNTI value assumed by the UE during PDCCH decoding.

MCS index table 1 for PDSCH and CP-OFDM-based PUSCH (or PUSCH without transform precoding) may be as shown in Table 11 below.

TABLE 11

| MCS | Modulation | Target code | |
|---|---|---|---|
| Index | Order | Rate R x | Spectral |
| I_{MCS} | Qₘ | [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

MCS index table 2 for PDSCH and CP-OFDM-based PUSCH (or PUSCH without transform precoding) may be as shown in Table 12 below.

TABLE 12

| MCS | Modulation | Target code | |
|---|---|---|---|
| Index | Order | Rate R x | Spectral |
| I_{MCS} | Qₘ | [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 8 | reserved |

MCS index table 3 for PDSCH and CP-OFDM-based PUSCH (or PUSCH without transform precoding) may be as shown in Table 13 below.

TABLE 13

| MCS | Modulation | Target code | |
|---|---|---|---|
| Index | Order | Rate R x | Spectral |
| I_{MCS} | Qₘ | [1024] | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 6 | 438 | 2.5664 |
| 22 | 6 | 466 | 2.7305 |
| 23 | 6 | 517 | 3.0293 |
| 24 | 6 | 567 | 3.3223 |
| 25 | 6 | 616 | 3.6094 |
| 26 | 6 | 666 | 3.9023 |
| 27 | 6 | 719 | 4.2129 |
| 28 | 6 | 772 | 4.5234 |

| | | |
|---|---|---|
| 29 | 2 | reserved |
| 30 | 4 | reserved |
| 31 | 6 | reserved |

MCS index table 1 for DFT-s-OFDM-based PUSCH (or PUSCH with transform precoding) may be as shown in Table 14 (MCS index table for PUSCH with transform precoding and 64 QAM) below.

TABLE 14

| MCS | Modulation | Target code | |
|---|---|---|---|
| Index | Order | Rate R x | Spectral |
| I_{MCS} | Qₘ | 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

MCS index table 2 for DFT-s-OFDM-based PUSCH (or PUSCH with transform precoding) may be as shown in Table 15 (MCS index table 2 for PUSCH with transform precoding and 64 QAM) below.

TABLE 15

| MCS | Modulation | Target code | |
|---|---|---|---|
| Index | Order | Rate R x | Spectral |
| I_{MCS} | Qₘ | 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

The MCS index table for PUSCH to which transform precoding (or discrete Fourier transform (DFT) precoding) and 64 QAM have been applied may be as shown in Table 16 below.

TABLE 16

| MCS | Modulation | Target code | |
|---|---|---|---|
| Index | Order | Rate R x | Spectral |
| I_{MCS} | Qₘ | 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

MCS index table 2 for PUSCH to which transform precoding and 64 QAM have been applied may be as shown in Table 17 below.

TABLE 17

| MCS | Modulation | Target code | |
|---|---|---|---|
| Index | Order | Rate R x | Spectral |
| I_{MCS} | Qₘ | 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

Hereinafter, a downlink control channel in a 5G communication system will be described in more detail with reference to the accompanying drawings.

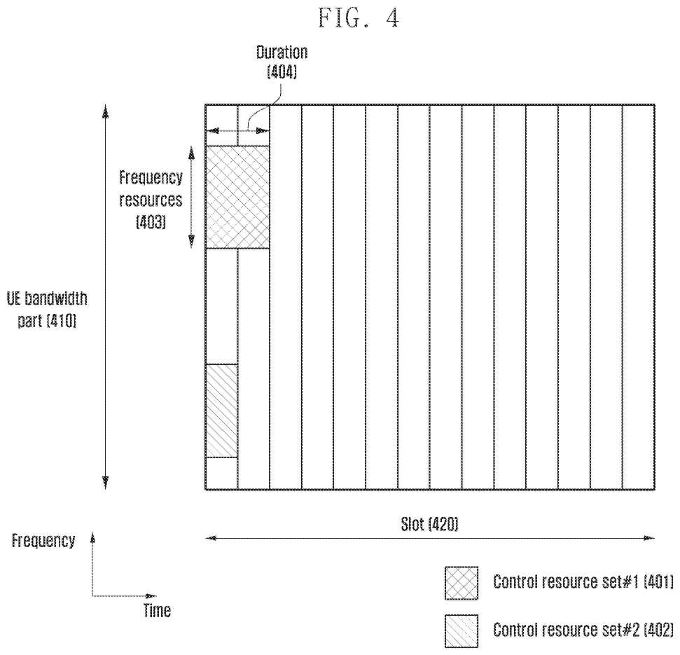

FIG. 4 illustrates an example of a control resource set used to transmit a downlink control channel in a 5G communication system.

Referring to FIG. 4, a UE BWP 410 may be configured along the frequency axis, and two control resource sets (control resource set #1 420 and control resource set #2 401) may be configured within one slot 402 along the time axis. The control resource sets 401 and 402 may be configured in a specific frequency resource 403 within the entire UE BWP 420 along the frequency axis. The control resource sets 401 and 402 may be each configured as one or multiple OFDM symbols along the time domain, and the number of the OFDM symbols may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G as described above may be configured for a UE by a base station through upper layer signaling (for example, SI, MIB, RRC signaling, etc.). The description that a control resource set is configured for a UE means that information such as a control resource set identity, the control resource set's frequency location, and the control resource set's symbol duration is provided. For example, this information may include the following pieces of information given in Table 18 below.

TABLE 18

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG-bundle, all |

ContiguousRBs},

| | |
|---|---|
| interleaverSize | ENUMERATED {n2, n3, n6} |

(interleaver size)

| | |
|---|---|
| shiftIndex | INTEGER(0..maxNrofPhysicalResourceBlock |
| s-1) | OPTIONAL |

```
      (interleaver shift)
    },
```

| | |
|---|---|
| nonInterleaved | NULL |

},

| | |
|---|---|
| tci-StatesPDCCH | SEQUENCE(SIZE (1..maxNrofTCI-States |
| PDCCH)) OF TCI-StateId | OPTIONAL, |

(QCL configuration information)

| tci-PresentInDCI | ENUMERATED {enabled} | |
|---|---|---|
| | OPTIONAL, | -- Need S |

}

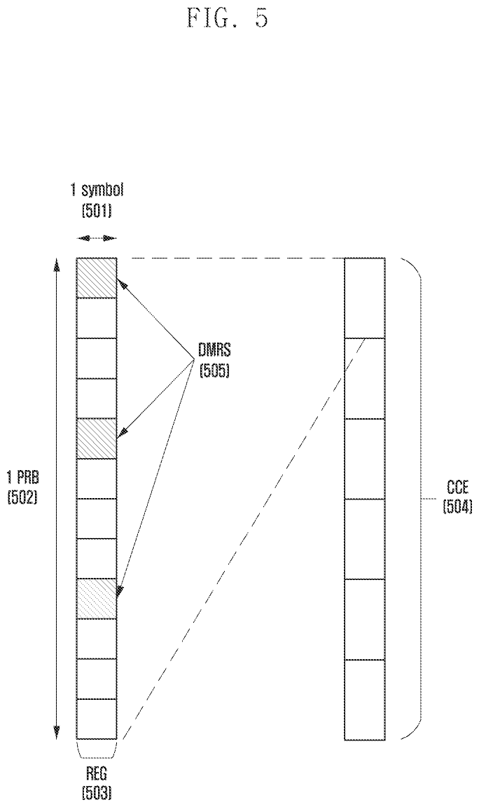

In Table 18, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding CORESET. FIG. 5 illustrates an example of a structure of a downlink control channel in a 5G wireless communication system.

That is, FIG. 5 illustrates an example of a basic unit of time and frequency resources constituting a downlink control channel available in a 5G system.

According to FIG. 5, the basic unit of time and frequency resources constituting a control channel may be referred to as a resource element group (REG) 503, and the REG 503 may be defined by one OFDM symbol % n along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element 504 as illustrated in FIG. 5, one CCE 504 may include multiple REGs 503. To describe the REG 503 illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs.

The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In a 5G system, a parameter for a search space regarding a PDCCH may be configured for the UE by the base station through upper layer signaling. For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, parameters of the search space for the PDCCH may include the following pieces of information given in Table 19 below.

TABLE 19

| | |
|---|---|
| SearchSpace ::= | SEQUENCE { |

```
  -- Identity of the search space. SearchSpaceId = 0 identifies the SearchSpace configured via
      PBCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

OPTIONAL,

| | |
|---|---|
| duration (monitoring duration) | INTEGER (2..2559) |
| monitoringSymbols WithinSlot | BIT STRING (SIZE (14)) |
| | OPTIONAL, |

(monitoring symbols within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8} |

,

| | |
|---|---|
| aggregationLevel2 | ENUMERATED {n0, n1, n2, n3, n4, n5, n6, n8} |

,

| | |
|---|---|
| aggregationLevel4 | ENUMERATED {n0, n1, n2, n3, n4, n5, n6, n8} |

,

| | |
|---|---|
| aggregationLevel8 | ENUMERATED {n0, n1, n2, n3, n4, n5, n6, n8} |

,

| | |
|---|---|
| aggregationLevel16 | ENUMERATED {n0, n1, n2, n3, n4, n5, n6, n8} |

},

| | |
|---|---|
| searchSpaceType | CHOICE { |

```
  (search space type)
    -- Configures this search space as common search space (CSS) and DCI formats to monitor
    .
```

| | |
|---|---|
| common | SEQUENCE { |

```
    (common search space)
    }
```

| | |
|---|---|
| ue-Specific | SEQUENCE { |

```
    (UE-specific search space)
    -- Indicates whether the UE monitors in this USS for DCI formats 0-0 and 1-0 or for form
    ats 0-1 and 1-1.
```

| | |
|---|---|
| formats | ENUMERATED {formats0-0-And-1-0, formats |

```
    0-1-And-1-1},
    ...
    }
```

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2. According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.
DCI format 0_0/1_0 with CRC scrambled by C-RNTI, CS-RNTI, MCS-C-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the examples given below are not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below.
C-RNTI: used to schedule a UE-specific PDSCH
MCS-C-RNTI: used to schedule a UE-specific PDSCH
Temporary cell RNTI (TC-RNTI): used to schedule a UE-specific PDSCH
CS-RNTI: used to schedule a semi-statically configured UE-specific PDSCH
RA-RNTI: used to schedule a PDSCH in a random access step
P-RNTI: used to schedule a PDSCH in which paging is transmitted
SI-RNTI: used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated above may follow the definitions given below.

TABLE 20

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no t |
| | ransmission is intended for the UE |
| 2_2 | Transmission of TPC commands for PUCCH |
| | and PUSCH |
| 2_3 | Transmission of a group of TPC commands f |
| | or SRS transmissions by one or more UEs |

In a 5G wireless communication system, the search space at aggregation level L in connection with CORESET p and search space set s may be expressed by Equation 1 below.

$$\{ ( {Y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) ⌊ \frac{{N}_{C C E , p}}{L} ⌋ \} + i \qquad Equation 1$$

L: aggregation level
n_{Cl}: carrier index
N_{CCE,p}: total number of CCEs existing in control resource set p

$${n}_{s , f}^{μ} :$$

slot index

$${M}_{s , max}^{( L )} :$$

number of PDCCH candidates at aggregation level L

$${m}_{s , {n}_{CI}} = 0 , … , {M}_{s , max}^{( L )} - 1 :$$

PDCCH candidate index at aggregation level L
i=0, . . . , L−1

$${Y}_{p , {n}_{s , f}^{μ}} = ( {A}_{p} \cdot {y}_{p , {n}_{s , f}^{μ} - 1} ) mod D , {Y}_{p , - 1} = {n}_{RNTI} \neq 0 ,$$

$${A}_{p} = 39827 for p mod 3 = 0 , {A}_{p} = 39829 for p mod 3 = 1 ,$$

$${A}_{p} = 39839 for p mod 3 = 2 , D = 65 \; 537$$

n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

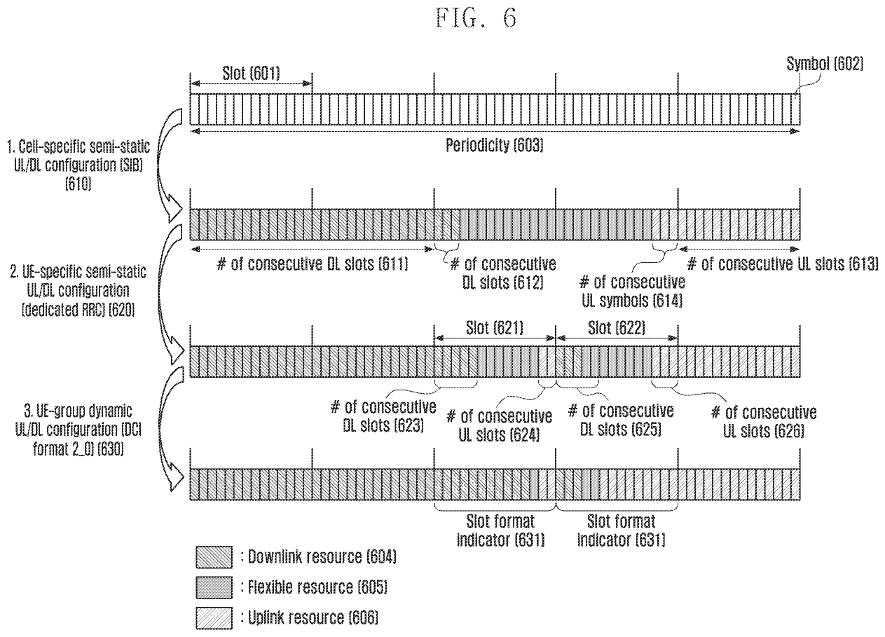

FIG. 6 is a diagram illustrating an example of an uplink-downlink configuration considered in the 5G communication system.

Referring to FIG. 6, a slot 601 may include 14 symbols 602. In the 5G communication system, an uplink-downlink configuration of a symbol/slot may have three stages. First, an uplink-downlink of a symbol/slot may be semi-statically configured in units of symbols via cell-specific configuration information 610 based on system information. Specifically, the cell-specific uplink-downlink configuration information based on the system information may include uplink-downlink pattern information and reference subcarrier information. In the uplink-downlink pattern information, a pattern periodicity 603, the number 611 of consecutive downlink slots from a start point of each pattern, the number 612 of symbols of a subsequent slot, the number 613 of consecutive uplink slots from the end of a pattern, and the number 614 of symbols of a subsequent slot may be indicated. In this case, a slot and a symbol that are indicated as neither uplink nor downlink may be determined as a flexible slot/symbol.

Second, based on user-specific configuration information via dedicated higher-layer signaling, slots 621 and 622 which are flexible slots or include flexible symbols may be indicated by the numbers 623 and 625 of consecutive downlink symbols from start symbols of the respective slots and the numbers 624 and 626 of consecutive uplink symbols from ends of the respective slots, or may be indicated as downlink for the entire slot or uplink for the entire slot.

In addition, finally, in order to dynamically change downlink signal transmission and uplink signal transmission intervals, symbols indicated as flexible symbols in the respective slots (i.e., symbols indicated as neither downlink nor uplink) may be indicated as downlink symbols, uplink symbols, or flexible symbols via SFIs 631 and 632 included in a downlink control channel. SFI may be selected as one index from a table in which uplink-downlink configurations of 14 symbols within one slot are preconfigured as shown in Table 21 below.

TABLE 21

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on |
| | tdd-UL-DL-ConfigurationCommon, or tdd-UL-DL- |
| | ConfigurationDedicated and, if any, on detected DCI formats |

### [CSI Framework]

In the NR system, there is a CSI framework for a base station to indicate a UE to measure and report channel state information (CSI). The CSI framework of the NR may include at least two elements which are resource settings and report settings, and the report settings may have connection relationships with the resource settings by referring to at least one ID of the resource settings.

According to an embodiment of the disclosure, the resource settings may include information related to a reference signal for the UE to measure channel state information. The base station may configure at least one resource setting for the UE. For example, the base station and the UE may transmit and receive signaling information, such as Table 22, to transfer information on the resource settings.

```
TABLE 22
  -- ASN1START
  -- TAG-CSI-RESOURCECONFIG-START
```

| | |
|---|---|
| CSI-ResourceConfig ::= | SEQUENCE { |
| csi-ResourceConfigId | CSI-ResourceConfigId, |
| csi-RS-ResourceSetList | CHOICE { |

| | |
|---|---|
| nzp-CSI-RS-SSB | SEQUENCE { |

nzp-CSI-RS-ResourceSetList SEQUENCE (SIZE (1..maxNrofNZP-CSI-RS-
ResourceSetsPerConfig)) OF NZP-CSI-RS-ResourceSetId

OPTIONAL, -- Need

R

| | |
|---|---|
| csi-SSB-ResourceSetList | SEQUENCE (SIZE (1..maxNrofCSI-SSB- |

ResourceSetsPerConfig)) OF CSI-SSB-ResourceSetId

OPTIONAL -- Need

R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resource Type | ENUMERATED { aperiodic, semiPersistent, periodic }, |

```
    ...
  }
  -- TAG-CSI-RESOURCECONFIG-STOP
  -- ASN1STOP
```

In Table 22, signaling information CSI-ResourceConfig includes information on each resource setting. Each CSI-ResourceConfig may include S (>1) CSI resource sets (given via higher-layer parameter csi-RS-ResourceSetList). Each CSI resource set may be positioned in a DL BWP identified by higher-layer parameter bwp-id, and a resource setting may be connected to a report setting of the same downlink BWP. According to the signaling information, each resource setting may include a resource set list (csi-RS-ResourceSetList) including a resource setting index (csi-ResourceConfigId), a BWP index (bwp-ID), a time domain transmission setting (resourceType) of a resource, or at least one resource set. The time domain transmission setting of the resource may be configured in aperiodic transmission, semi-persistent transmission, or periodic transmission. For a periodic or semi-persistent CSI resource setting, the number of CSI-RS resource sets may be limited to S=1, and a configured periodicity and slot offset may be given based on the numerology of the DL BWP identified by bwp-id.

The resource set list may be sets including resource sets for channel measurement or sets including resource sets for interference measurement. If the resource set list is sets including resource sets for channel measurement, each resource set may include at least one resource, which may be an index of an SS/PBCH block or a CSI reference signal (CSI-RS) resource. If the resource set list is sets including resource sets for interference measurement, each resource set may include at least one interference measurement resource (CSI interference measurement (CSI-IM)).

For example, when the resource set includes the CSI-RS, the base station and the UE may transmit and receive signaling information, such as Table 23, to transfer information on the resource set.

TABLE 23
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

```
OPTIONAL, -- Need R
    ...
  }
  -- TAG-NZP-CSI-RS-RESOURCESET-STOP
  -- ASN1STOP
```

In Table 23, signaling information NZP-CSI-RS-ResourceSet includes information on each resource setting. According to the signaling information, each resource set may include at least information on a resource set index (nzp-CSI-ResourceSetId) or an index set of included CSI-RSs (nzp-CSI-RS-Resources), and may include a part of information on a spatial domain transmission filter of an included CSI-RS resource (repetition) or whether the included CSI-RS resource is used for tracking (trs-Info). The CSI-RS may be the most representative reference signal included in the resource set. The base station and the UE may transmit and receive signaling information, such as Table 24, to transfer information on the CSI-RS resource.

```
TABLE 24
  -- ASN1START
  -- TAG-NZP-CSI-RS-RESOURCE-START
```

| | |
|---|---|
| NZP-CSI-RS-Resource ::= | SEQUENCE { |
| nzp-CSI-RS-ResourceId | , |
| resourceMapping | CSI-RS-ResourceMapping, |
| powerControlOffset | INTEGER (−8..15), |
| powerControlOffsetSS | ENUMERATED{db-3, db0, db3, db6} |

OPTIONAL, -- Need R

| scramblingID | , | |
|---|---|---|
| periodicityAndOffset | CSI-ResourcePeriodicity AndOffset | OPTIONAL, |

-- Cond PeriodicOrSemiPersistent

| | | |
|---|---|---|
| qcl-InfoPeriodicCSI-RS | TCI-StateId | OPTIONAL, -- Cond |

```
Periodic
    ...
  }
  -- TAG-NZP-CSI-RS-RESOURCE-STOP
  -- ASN1STOP
```

In Table 24, signaling information NZP-CSI-RS-Resource includes information on each CSI-RS. Information included in the signaling information NZP-CSI-RS-Resource may have the following meanings. —nzp-CSI-RS-ResourceId: a CSI-RS resource index
resourceMapping: resource mapping information of a CSI-RS resource
powerControlOffset: a ratio between PDSCH energy per RE (EPRE) and CSI-RS EPRE
powerControlOffsetSS: a ratio between SS/PBCH block EPRE and CSI-RS EPRE
scramblingID: a scrambling index of a CSI-RS sequence
periodicity AndOffset: a transmission periodicity and a slot offset of a CSI-RS resource
qcl-InfoPeriodicCSI-RS: TCI-state information if a corresponding CSI-RS is a periodic CSI-RS
resourceMapping included in the signaling information NZP-CSI-RS-Resource indicates resource mapping information of the CSI-RS resource, and may include frequency resource RE mapping, the number of antenna ports, symbol mapping, a code division multiplexing (CDM) type, a frequency resource density, and frequency band mapping information. According to this, the configurable number of ports, frequency resource density, CDM type, and time-frequency domain RE mapping may have values determined to be one of the rows in Table 25 below.

TABLE 25

| | Ports | Density | | | CDM group | | |
|---|---|---|---|---|---|---|---|
| Row | X | ρ | cdm-Type | (k̅, l̅) | index j | k′ | l′ |
| 1 | 1 | 3 | No CDM | (k₀, l₀), (k₀ + 4, l₀), (k₀ + 8, l₀) | 0, 0, 0 | 0 | 0 |
| 2 | 1 | 1, 0.5 | No CDM | (k₀, l₀) | 0 | 0 | 0 |
| 3 | 2 | 1, 0.5 | FD-CDM2 | (k₀, l₀) | 0 | 0, 1 | 0 |
| 4 | 4 | 1 | FD-CDM2 | (k₀, l₀), (k₀ + 2, l₀) | 0, 1 | 0, 1 | 0 |
| 5 | 4 | 1 | FD-CDM2 | (k₀, l₀), (k₀, l₀ + 1) | 0, 1 | 0, 1 | 0 |
| 6 | 8 | 1 | FD-CDM2 | (k₀, l₀), (k₁, l₀), k₂, l₀), (k [symbol] , l₀) | 0, 1, 2, 3 | 0, 1 | 0 |
| 7 | 8 | 1 | FD-CDM2 | (k₀, l₀), (k₁, l₀), (k₀, l₀ + 1), (k₁, l₀ + 1) | 0, 1, 2, 3 | 0, 1 | 0 |
| 8 | 8 | 1 | CDM4 | (k₀, l₀), (k₁, l₀) | 0, 1 | 0, 1 | 0, 1 |
| | | | (FD2, TD2) | | | | |
| 9 | 12 | 1 | FD-CDM2 | (k₀, l₀), (k₁, l₀), (k₂, l₀), (k [symbol] , l₀), k₄, l₀), (k [symbol] , l₀) | 0, 1, 2, | 0, 1 | 0 |
| | | | | | 3, 4, 5 | | |
| 10 | 12 | 1 | CDM4 | (k₀, l₀), (k₁, l₀), (k₂, l₀) | 0, 1, 2 | 0, 1 | 0, 1 |
| | | | (FD2, TD2) | | | | |
| 11 | 16 | 1, 0.5 | FD-CDM2 | (k₀, l₀), (k₁, l₀), (k₂, l₀), (k [symbol] , l₀), | 0, 1, 2, 3, | 0, 1 | 0 |
| | | | | (k₀, l₀ + 1), (k₁, l₀ + 1), (k₂, l₀ + 1), (k₃, l₀ + 1) | 4, 5, 6, 7 | | |
| 12 | 16 | 1, 0.5 | CDM4 | (k₀, l₀), (k₁, l₀), (k₂, l₀), (k [symbol] , l₀) | 0, 1, 2, 3 | 0, 1 | 0, 1 |
| | | | (FD2, TD2) | | | | |
| 13 | 24 | 1, 0.5 | FD-CDM2 | (k₀, l₀), (k₁, l₀), (k₂, l₀), (k₀, l₀ + 1), (k₁, l₀ + 1), (k₂, l₀ + 1), | 0, 1, 2, 3, | 0, 1 | 0 |
| | | | | (k₀, l₁), (k₁, l₁), (k₂, l₁), (k₀, l₁ + 1), (k₁, l₁ + 1), (k₂, l₁ + 1) | 4, 5, 6, 7, | | |
| | | | | | 8, 9, 10, 11 | | |
| 14 | 24 | 1, 0.5 | CDM4 | (k₀, l₀), (k₁, l₀), (k₂, l₀), (k₀, l₁), (k₁, l₁), (k₂, l₁) | 0, 1, 2, 3, | 0, 1 | 0, 1 |
| | | | (FD2, TD2) | | 4, 5 | | |
| 15 | 24 | 1, 0.5 | CDM8 | (k₀, l₀), (k₁, l₀), (k₂, l₀), | 0, 1, 2 | 0, 1 | 0, 1 |
| | | | (FD2, TD4) | | | | 2, 3 |
| 16 | 32 | 1, 0.5 | FD-CDM2 | (k₀, l₀), (k₁, l₀), (k₂, l₀), (k₃, l₀), | 0, 1, 2, 3, | 0, 1 | 0 |
| | | | | (k₀, l₀ + 1), (k₁, l₀ + 1), (k₂, l₀ + 1), (k₃, l₀ + 1), | 4, 5, 6, 7, | | |
| | | | | (k₀, l₁), (k₁, l₁), (k₂, l₁), (k₃, l₁), | 8, 9, 10, 11, | | |
| | | | | (k₀, l₁ + 1), (k₁, l₁ + 1), (k₂, l₁ + 1), (k₃, l₁ + 1) | 12, 13, 14, 15 | | |
| 17 | 32 | 1, 0.5 | CDM4 | (k₀, l₀), (k₁, l₀), (k₂, l₀), (k₃, l₀), (k₀, l₁), (k₁, l [symbol] ), | 0, 1, 2, 3, | 0, 1 | 0, 1 |
| | | | (FD2, TD2) | (k₂, l₀), (k [symbol] , l [symbol] ) | 4, 5, 6, 7 | | |
| 18 | 32 | 1, 0.5 | CDM8 | (k₀, l₀), (k₁, l₀), (k₂, l₀), (k₃, l₀) | 0, 1, 2, 3 | 0, 1 | 0, 1, |
| | | | (FD2, TD4) | | | | 2, 3 |

[symbol]

indicates data missing or illegible when filed

Table 25 shows a frequency resource density, a CDM type, a frequency domain and time domain start position (k̅, l̅) of a CSI-RS component RE pattern, and the number (k′) of frequency domain REs and number (l′) of time domain REs of the CSI-RS component RE pattern, which are configurable according to the number of CSI-RS ports (X). The CSI-RS component RE pattern described above may be a basic unit for configuring a CSI-RS resource. The CSI-RS component RE pattern may include YZ REs via Y=1+max(k′) REs on the frequency domain and Z=1+max(l′) REs on the time domain.

If the number of CSI-RS ports is 1 port, a CSI-RS RE position may be designated in a PRB without limitation of subcarriers, and the CSI-RS RE position may be designated by a 12-bit bitmap. If the number of CSI-RS ports is {2, 4, 8, 12, 16, 24, 32} ports and Y=2, a CSI-RS RE position may be designated in every two subcarriers in a PRB, and the CSI-RS RE positions may be designated by a 6-bit bitmap. If the number of CSI-RS ports is 4 ports and Y=4, a CSI-RS RE position may be designated in every four subcarriers in a PRB, and the CSI-RS RE positions may be designated by a 3-bit bitmap. Similarly, a time domain RE position may be designated by a bitmap having a total of 14 bits. In this case, depending on a Z value of Table 25, the length of the bitmap may change like frequency position designation, but since the principle is similar to the above description, any redundant description will be omitted hereinafter.

According to an embodiment of the disclosure, the report settings may have connection relationships with the resource settings by referencing at least one ID of the resource settings, and the resource setting(s) having the connection relationship with the report settings provide configuration information including information on a reference signal for channel information measurement. When the resource setting(s) having a connection relationship with the report setting is used for channel information measurement, measured channel information may be used for channel information reporting according to a reporting method configured in the report setting having the connection relationship.

According to an embodiment of the disclosure, the report setting may include configuration information related to the CSI reporting method. As an example, the base station and the UE may transmit and receive signaling information, such as Table 26, to transfer information on the report setting.

```
TABLE 26
  -- ASN1START
  -- TAG-CSI-REPORTCONFIG-START
```

| CSI-ReportConfig ::= | SEQUENCE { | |
|---|---|---|
| reportConfigId | CSI-ReportConfigId, | |
| carrier | ServCellIndex | OPTIONAL, -- Need S |

| | |
|---|---|
| resourcesForChannelMeasurement | CSI-ResourceConfigId, |

| | | |
|---|---|---|
| csi-IM-ResourcesForInterference | CSI-ResourceConfigId | OPTIONAL, -- |

Need R

| | | |
|---|---|---|
| nzp-CSI-RS-ResourcesForInterference | CSI-ResourceConfigId | OPTIONAL, -- |

Need R

| | |
|---|---|
| reportConfigType | CHOICE { |
| periodic | SEQUENCE { |

| | |
|---|---|
| reportSlotConfig | CSI-ReportPeriodicityAndOffset, |

| | |
|---|---|
| pucch-CSI-ResourceList | SEQUENCE (SIZE (1..maxNrofBWPs)) OF |

PUCCH-CSI-Resource
},

| | |
|---|---|
| semiPersistentOnPUCCH | SEQUENCE { |

| | |
|---|---|
| reportSlotConfig | CSI-ReportPeriodicityAndOffset, |

| | |
|---|---|
| pucch-CSI-ResourceList | SEQUENCE (SIZE (1..maxNrofBWPs)) OF |

PUCCH-CSI-Resource
},

| | |
|---|---|
| semiPersistentOnPUSCH | SEQUENCE { |

| | |
|---|---|
| reportSlotConfig | ENUMERATED {sl5, sl10, sl20, sl40, sl80, sl160, |

sl320},

| | |
|---|---|
| reportSlotOffsetList | SEQUENCE (SIZE (1..maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
      }
    },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |

| | |
|---|---|
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |

| | |
|---|---|
| cri-RI-LI-PMI-CQI | NULL |

},

| | |
|---|---|
| reportFreqConfiguration | SEQUENCE { |

| | |
|---|---|
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |

| | |
|---|---|
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |

| | |
|---|---|
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

OPTIONAL, --

}
Need R

| | |
|---|---|
| timeRestrictionForChannelMeasurements | ENUMERATED {configured, |

notConfigured},

| | |
|---|---|
| timeRestrictionForInterferenceMeasurements | ENUMERATED {configured, |

notConfigured},

| | |
|---|---|
| codebookConfig | OPTIONAL, -- Need |

R

| | |
|---|---|
| dummy | ENUMERATED {n1, n2} |

OPTIONAL, -- Need R

| | |
|---|---|
| groupBasedBeamReporting | CHOICE { |

| | |
|---|---|
| enabled | NULL, |
| disabled | SEQUENCE { |

| | |
|---|---|
| nrofReportedRS | ENUMERATED {n1, n2, n3, n4} |

```
OPTIONAL -- Need S
      }
    }
```

| | |
|---|---|
| cqi-Table | ENUMERATED {table1, table2, table3, spare1} |

OPTIONAL, -- Need R

| | |
|---|---|
| subband Size | ENUMERATED {value1, value2}, |

| | |
|---|---|
| non-PMI-PortIndication | SEQUENCE (SIZE (1..maxNrofNZP-CSI-RS- |

```
ResourcesPerConfig)) OF PortIndexFor8Ranks OPTIONAL, -- Need R
    ...,
    [[
```

| | |
|---|---|
| semiPersistentOnPUSCH-v1530 | SEQUENCE { |

| | |
|---|---|
| reportSlotConfig-v1530 | ENUMERATED {sl4, sl8, sl16} |

| | |
|---|---|
| } | OPTIONAL -- |

```
Need R
    ]]
  }
```

In Table 26, signaling information CSI-ReportConfig includes information on each report setting. Information included in the signaling information CSI-ReportConfig may have the following meanings. —reportConfigId: a report setting index
carrier: a serving cell index
resourcesForChannelMeasurement: a resource setting index for channel measurement, which has a connection relationship with the report setting
csi-IM-ResourcesForInterference: a resource setting index having a CSI-IM resource for interference measurement, which has a connection relationship with the report setting
nzp-CSI-RS-ResourcesForInterference: a resource setting index having a CSI-RS resource for interference measurement, which has a connection relationship with the report setting
reportConfigType: reportConfigType indicates a time domain transmission configuration and a transmission channel of channel reporting, and may have an aperiodic transmission, semi-persistent PUCCH transmission, semi-persistent PUSCH transmission, or periodic transmission configuration
reportQuantity: reportQuantity indicates a type of channel information to be reported, and may have channel information types (“cri-RI-PMI-CQI”, “cri-RI-il”, “cri-RI-il-CQI”, “cri-RI-CQI”, “cri-RSRP”, “ssb-Index-RSRP”, or “cri-RI-LI-PMI-CQI”) in a case of not transmitting a channel report (“none”) and in a case of transmitting a channel report. Here, elements included in the channel information type refer to a channel quality indicator (CQI), a precoding matrix indicator (PMI), a CSI-RS resource indicator (CRI), an SS/PBCH block resource indicator (SSBRI), a layer indicator (LI), a rank indicator (RI), and/or layer 1—reference signal received power (L1-RSRP).
reportFreqConfiguration: reportFreqConfiguration indicates whether channel information to be reported includes only information on the entire band (wideband) or includes information on each subband, and may have configuration information on a subband including the channel information if information on each subband is included.
timeRestrictionForChannelMeasurements: whether the time domain is limited for a reference signal for channel measurement among reference signals referenced by channel information to be reported
timeRestrictionForInterferenceMeasurements: whether time domain is limited for a reference signal for interference measurement among reference signals referenced by channel information to be reported
codebookConfig: codebook information referenced by channel information to be reported
groupBasedBeamReporting: whether beam grouping is performed for channel reporting
cqi-Table: a CQI table index referenced by channel information to be reported
subbandSize: an index indicating a subband size of channel information
non-PMI-PortIndication: port mapping information referenced when reporting non-PMI channel information

When the base station indicates channel information reporting via higher-layer signaling or L1 signaling, the UE may perform channel information reporting by referring to the aforementioned configuration information included in the indicated report setting.

The base station may indicate CSI reporting to the UE via higher-layer signaling including RRC signaling or medium access control (MAC) CE (control element) signaling, or L1 signaling (e.g., common DCI, group-common DCI, or UE-specific DCI).

For example, the base station may indicate aperiodic channel information reporting (CSI report) to the UE via higher-layer signaling or DCI using DCI format 0 1. The base station configures, via higher-layer signaling, a parameter for aperiodic CSI reporting of the UE or multiple CSI report trigger states including a parameter for CSI reporting. The parameter for CSI reporting or the CSI report trigger state may include a set including slot intervals or available slot intervals between a PDCCH including the DCI and a PUSCH including the CSI report, a reference signal ID for channel state measurement, a type of included channel information, etc.

When the base station indicates some of the multiple CSI report trigger states to the UE via the DCI, the UE may report channel information according to a CSI report setting of the report settings configured for the indicated CSI report trigger state. Aperiodic CSI reporting may be triggered by a CSI request field in aforementioned DCI format 0_1 corresponding to scheduling DCI for a PUSCH. A CSI request indicator may be configured to have N_{TS} (=0, 1, 2, 3, 4, 5, or 6) bits, and may be determined by higher-layer signaling (reportTriggerSize). One trigger state among one or multiple aperiodic CSI report trigger states which may be configured via higher-layer signaling (CSI-AperiodicTriggerStateList) may be triggered by the CSI request indicator.
If all bits in the CSI request field are 0, this may indicate that CSI reporting is not requested.
If the number M of configured CSI trigger states in CSI-AperiodicTriggerStateLite is greater than 2^{NTs}−1, M CSI trigger states may be mapped to 2^{NTs}−1 trigger states according to a predefined mapping relation, and one trigger state among the 2^{NTs}−1 trigger states may be indicated via the CSI request field.
If the number M of the configured CSI trigger states in CSI-AperiodicTriggerStateLite is less than or equal to 2^{NTs}−1, one of the M CSI trigger states may be indicated via the CSI request field.

Table 27 below shows examples of relationships between CSI request indicators and CSI trigger states that may be indicated by the indicators.

TABLE 27

| CSI request | | CSI- | CSI- |
|---|---|---|---|
| field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The channel information reporting may be performed via a PUSCH scheduled in DCI format 0_1. When one bit corresponding to an uplink data indicator (UL-SCH indicator) in DCI format 0_1 indicates 1, the UE may multiplex acquired CSI and uplink data (UL-SCH) on a PUSCH resource scheduled by DCI format 0_1 so as to transmit the same. When one bit corresponding to the uplink data indicator (UL-SCH indicator) in DCI format 0_1 indicates 0, the UE may map only the CSI, without uplink data (UL-SCH), to the PUSCH resource scheduled by DCI format 0_1 so as to transmit the same. Time domain resource allocation of the PUSCH including the CSI report of the UE may be performed via a slot interval with respect to a PDCCH indicated via the DCI, an indication of a start symbol and a symbol length within a slot for the time domain resource allocation of the PUSCH, etc. For example, a position of the slot, in which the PUSCH including the CSI report of the UE is transmitted, is indicated via the slot interval with respect to the PDCCH indicated via the DCI, and the start symbol and symbol length within the slot can be indicated via a time domain resource assignment field of the DCI described above. A periodicity and a slot offset of the PUSCH resource in which CSI is to be transmitted may be given based on a numerology of a UL BWP configured for transmission of the CSI report. For example, the base station may indicate, to the UE via the DCI using DCI format 0_1, semi-persistent CSI reporting transmitted on the PUSCH. The base station may activate or deactivate semi-persistent CSI reporting transmitted on the PUSCH, via DCI scrambled by an SP-SCI-RNTI. When semi-persistent CSI reporting is activated, the UE may periodically report channel information according to the configured slot interval. When semi-persistent CSI reporting is deactivated, the UE may stop activated periodic channel information reporting.

The base station may configure, via higher-layer signaling, a parameter for semi-persistent CSI reporting of the UE or multiple CSI report trigger states including a parameter for semi-persistent CSI reporting. The parameter for CSI reporting or the CSI report trigger state may include a set including slot intervals or available slot intervals between a PDCCH including DCI indicating CSI reporting and a PUSCH including a CSI report, a slot interval between a slot in which higher-layer signaling indicating CSI reporting is activated and the PUSCH including the CSI report, a slot interval periodicity of the CSI reporting, a type of included channel information, etc.

When the base station activates some of the multiple CSI report trigger states or some of multiple report settings for the UE via the higher-layer signaling or the DCI, the UE may report channel information according to a report setting included in the indicated CSI report trigger states or a CSI report setting configured in the activated report settings. The channel information reporting may be performed via the PUSCH that is semi-persistently scheduled in DCI format 0_1 scrambled by an SP-CSI-RNTI. Time domain resource allocation of the PUSCH including the CSI report of the UE may be performed via a slot interval periodicity of the CSI report, a slot interval from a slot in which higher-layer signaling is activated or a slot interval with respect to the PDCCH indicated via the DCI, an indication of a start symbol and a symbol length within a slot for the time domain resource allocation of the PUSCH, etc. For example, a position of the slot, in which the PUSCH including the CSI report of the UE is transmitted, is indicated via the slot interval with respect to the PDCCH indicated via the DCI, and the start symbol and symbol length within the slot can be indicated via the time domain resource assignment field of DCI format 0_1 described above.

For example, the base station may indicate, to the UE via higher-layer signaling such as MAC-CE signaling, semi-persistent CSI reporting transmitted on a PUCCH. Via the MAC-CE signaling, the base station may activate or deactivate the semi-persistent CSI reporting transmitted on a PUCCH. When semi-persistent CSI reporting is activated, the UE may periodically report channel information according to the configured slot interval. When semi-persistent CSI reporting is deactivated, the UE may stop activated periodic channel information reporting.

The base station may configure a parameter for semi-persistent CSI reporting of the UE via higher-layer signaling. The parameter for CSI reporting may include a PUCCH resource in which a CSI report is transmitted, a slot interval periodicity of the CSI report, a type of included channel information, etc. The UE may transmit the CSI report via the PUCCH. Alternatively, if the PUCCH for the CSI report overlaps with a PUSCH, the CSI report may be transmitted via the PUSCH. A position of a slot for transmission of the PUCCH including the CSI report may be indicated via the slot interval periodicity of the CSI report, which is configured via higher-layer signaling, and a slot interval between the slot in which higher-layer signaling is activated and the PUCCH including the CSI report, and a start symbol and a symbol length within the slot can be indicated via a start symbol and symbol length in which the PUCCH resource configured via higher-layer signaling has been allocated. The periodicity and slot offset of the PUCCH or PUSCH resource in which CSI is to be transmitted may be given based on a numerology of a UL BWP configured for transmission of the CSI report.

For example, the base station may indicate, to the UE via higher signaling, periodic CSI reporting. The base station may activate or deactivate periodic CSI reporting, via higher-layer signaling including RRC signaling. When periodic CSI reporting is activated, the UE may periodically report channel information according to a configured slot interval. When periodic CSI reporting is deactivated, the UE may stop activated periodic channel information reporting.

The base station may configure a report setting including a parameter for periodic CSI reporting of the UE via higher-layer signaling. The parameter for CSI reporting may include a PUCCH resource setting for CSI reporting, a slot interval between a slot in which higher-layer signaling indicating CSI reporting is activated and a PUCCH including a CSI report, a slot interval periodicity of CSI reporting, a reference signal ID for channel state measurement, a type of included channel information, etc. The UE may transmit the CSI report via the PUCCH. Alternatively, if the PUCCH for the CSI report overlaps with a PUSCH, the CSI report may be transmitted via the PUSCH. A position of a slot for transmission of the PUCCH including the CSI report may be indicated via the slot interval periodicity of the CSI report, which is configured via higher-layer signaling, and a slot interval between the slot in which higher-layer signaling is activated and the PUCCH including the CSI report, and a start symbol and a symbol length within the slot can be indicated via a start symbol and symbol length in which the PUCCH resource configured via higher-layer signaling has been allocated. A periodicity and a slot offset of the PUCCH resource in which CSI is to be transmitted may be given based on a numerology of a UL BWP configured for transmission of the CSI report.

When the base station indicates aperiodic CSI reporting or semi-persistent CSI reporting to the UE via DCI, the UE may determine whether to perform valid channel reporting via the indicated CSI reporting by considering a channel computation time required for CSI reporting (CSI computation time).

For the aperiodic CSI reporting or semi-persistent CSI reporting indicated via the DCI, the UE may report a valid CSI report from an uplink symbol after Z symbols subsequent to the end of the last symbol included in a PDCCH including the DCI that indicates the CSI reporting, and the Z symbols may vary according to a numerology of a downlink BWP corresponding to the PDCCH including the DCI that indicates the CSI reporting, a numerology of an uplink BWP corresponding to the PUSCH in which the CSI report is transmitted, or a type or characteristics of channel information reported in the CSI report (a report quantity, a frequency band granularity, the number of ports of the reference signal, a codebook type, etc.).

In other words, in order for a certain CSI report to be determined as a valid CSI report (in order for the CSI report to be a valid CSI report), uplink transmission of the CSI report, including timing advance, should be prevented from being performed before a Z_{ref} symbol. In this case, the Z_{ref} symbol may be an uplink symbol that initiates a cyclic prefix (CP) after time T_{proc,CSI}=(Z)(2048+144)·_{K}2^{-μ}·T_{c} from the moment that the last symbol of the triggering PDCCH ends. Here, a detailed Z value conforms to the following description, and T_{c}=1/(Δfₘₐₓ·N_{f}), Δfₘₐₓ=480·10³ Hz, N_{f}=4096, κ=64, and μ is a numerology. In this case, μ may be agreed to use one of μ_{PDCCH}, μ_{CSI-RS}, and μ_{UL}, which represents a largest T_{proc,CSI} value, μ_{PDCCH} may denote a subcarrier spacing used for PDCCH transmission, μ_{CSI-RS} may denote a subcarrier spacing used for CSI-RS transmission, and μ_{UL} may denote a subcarrier spacing of an uplink channel used for uplink control information (UCI) transmission for CSI reporting. In another example, μ can be agreed to use one of μ_{PDCCH} and μ_{UL}, which represents a largest T_{proc,CSI} value. The description above may be referenced for the definition of μ_{PDCCH} and HUL. For convenience of the following description, satisfaction of the conditions above is referred to as satisfaction of CSI reporting validity condition 1.

In addition, when the reference signal for channel measurement for aperiodic CSI reporting indicated to the UE via DCI is an aperiodic reference signal, the UE may report a valid CSI report from an uplink symbol after Z′ symbols subsequent to the end of the last symbol including the reference signal, and the Z′ symbols may vary according to a numerology of a downlink BWP corresponding to the PDCCH including the DCI that indicates the CSI reporting, a numerology of a bandwidth corresponding to the reference signal for channel measurement for the CSI reporting, a numerology of an uplink BWP corresponding to the PUSCH in which the CSI report is transmitted, and a type or characteristics of channel information reported in the CSI report (a report quantity, a frequency band granularity, the number of ports of the reference signal, a codebook type, etc.).

In other words, in order for a CSI report to be determined as a valid CSI report (in order for the CSI report to be a valid CSI report), uplink transmission of the CSI report, including timing advance, should be prevented from being performed before a Z_{ref} symbol. In this case, the Z_{ref} symbol may be an uplink symbol that initiates a CP after time T′_{proc,CSI}=(Z′)(2048+144)·_{K}2^{-μ}·T_{c} from the moment that the last symbol of the aperiodic CSI-RS or aperiodic CSI-IM triggered by the triggering PDCCH ends. Here, a detailed Z′ value conforms to the following description, and T_{c}=1/(Δfₘₐₓ·N_{f}), Δfₘₐₓ=480·103 Hz, N_{f}=4096, κ=64, and μ is a numerology. In this case, μ may be agreed to use one of μ_{PDCCH}, μ_{CSI-RS}, and μ_{UL}, which represents a largest T_{proc,CSI} value, μ_{PDCCH} may denote a subcarrier spacing used for PDCCH transmission, μ_{CSI-RS} may denote a subcarrier spacing used for CSI-RS transmission, and μ_{UL} may denote a subcarrier spacing of an uplink channel used for uplink control information (UCI) transmission for CSI reporting. In another example, μ can be agreed to use one of μ_{PDCCH} and μ_{UL}, which represents a largest T_{proc,CSI} value. The description above may be referenced for the definition of μ_{PDCCH} and μ_{UL}. For convenience of the following description, satisfaction of the conditions above is referred to as satisfaction of CSI reporting validity condition 2.

If the base station indicates aperiodic CSI reporting for the aperiodic reference signal to the UE via DCI, the UE may perform valid CSI reporting from a first uplink symbol that satisfies both a time point after Z symbols subsequent to the end of the last symbol included in the PDCCH including the DCI that indicates the CSI reporting and a time point after Z′ symbols subsequent to the end of the last symbol including the reference signal. In other words, for the aperiodic CSI reporting based on the aperiodic reference signal, a CSI report is determined to be a valid CSI report when both CSI reporting validity conditions 1 and 2 are satisfied.

If a CSI reporting time point indicated by the base station fails to satisfy CSI computation time requirements, the UE may determine that the CSI report is not valid and may not consider updating a channel information state for CSI reporting.

The aforementioned Z and Z′ symbols for calculation of the CSI computation time conform to the following Table 28 and Table 29. For example, if channel information reported in the CSI report includes only wideband information, the number of ports of the reference signal is 4 or less, there is one reference signal resource, and a codebook type is “typeI-SinglePanel”, or a type (report quantity) of the reported channel information is “cri-RI-CQI”, the Z and Z′ symbols conform to Z₁, Z₁′ values in Table 29. Hereinafter, this is referred to as delay requirement 2. In addition, if the PUSCH including the CSI report includes neither a transport block (TB) nor a hybrid automatic repeat request acknowledgment (HARQ-ACK), and a CPU occupation of the UE is 0, the Z and Z′ symbols conform to the Z₁ and Z₁′ values of Table 28, and this is referred to as delay requirement 1. The CPU occupation described above is described in detail below. In addition, if the report quantity is “cri-RSRP” or “ssb-Index-RSRP”, the Z and Z′ symbols may conform to Z₃ and Z₃′ values in Table 29. X₁, X₂, X₃, and X₄ of Table 29 represent a UE capability for a beam reporting time, and KB₁ and KB₂ of Table 29 represent a UE capability for a beam changing time. When not corresponding to the type or characteristics of the channel information reported in the CSI report, the Z and Z′ symbols conform to Z₂ and Z₂′ values of Table 29.

TABLE 28

Z1 [symbols]

| μ | Z1 | Z′1 |
|---|---|---|
| 0 | 10 | 8 |
| 1 | 13 | 11 |
| 2 | 25 | 21 |
| 3 | 43 | 36 |

TABLE 29

| | Z1 [symbols] | | Z2 [symbols] | | Z3 [symbols] | |
|---|---|---|---|---|---|---|
| μ | Z1 | Z′1 | Z2 | Z′2 | Z3 | Z′ |
| 0 | 22 | 16 | 40 | 37 | 22 | X1 |
| 1 | 33 | 30 | 72 | 69 | 33 | X2 |
| 2 | 44 | 42 | 141 | 140 | min(44, X3 + KB1) | X3 |
| 3 | 97 | 85 | 152 | 140 | min(97, X4 + KB2) | X4 |

When the base station indicates, to the UE, aperiodic, semi-persistent, or periodic CSI reporting, the base station may configure a CSI reference resource in order to determine a reference time and a frequency resource for a channel for reporting in a CSI report. A frequency of the CSI reference resource may be carrier and subband information for CSI measurement, indicated in a CSI report configuration, and may each correspond to the carrier and reportFreqConfiguration in Table 26. A time of the CSI reference resource may be defined based on a time at which the CSI report is transmitted. For example, when CSI report #X is indicated to be transmitted in uplink slot n′ of a carrier and BWP in which a CSI report is to be transmitted, a time of a CSI reference resource of CSI report #X may be defined to be downlink slot n-n_{CSI-ref} of a carrier and BWP for CSI measurement. Downlink slot n is calculated as n=[n′. 2^{μ}^{_{DL}}/2^{μ}^{_{UL}}], when a numerology of the carrier and BWP for CSI measurement is referred to as μ_{DL}, and a numerology of the carrier and BWP for transmission of CSI report #X is referred to as HUL. When CSI report #X transmitted in uplink slot n′ is a semi-persistent or periodic CSI report, slot interval n_{CSI-ref} between downlink slot n and a csi reference signal conforms to n_{csi-ref}=4·2^{μ}^{_{DL}} if a single csi-rs/ssb resource is connected to the CSI report and conforms to n_{CSI-ref}=5·2^{μ}^{_{DL}} if multiple CSI-RS resources are connected to the CSI report, according to the number of CSI-RS/SSB resources for channel measurement. When CSI report #X transmitted in uplink slot n′ is an aperiodic CSI report, n_{CSI-ref} may be calculated as

$${n}_{CSI - ref} = ⌊ {Z}^{′} / {N}_{s y m b}^{slot} ⌋$$

by considering CSI computation time Z′ for channel measurement.

$${N}_{s y m b}^{slot}$$

is the number of symbols included in one slot, and

$${N}_{s y m b}^{slot} = 14$$

is assumed in NR.

When the base station indicates, via higher-layer signaling or DCI, the UE to transmit a certain CSI report in uplink slot n′, the UE may report CSI by performing channel measurement or interference measurement with respect to a CSI-RS resource, a CSI-IM resource, and an SSB resource, which are transmitted not later than a CSI reference resource slot of the CSI report transmitted in uplink slot n′, among CSI-RS resources, CSI-IM resources, or SSB resources associated with the CSI report. The CSI-RS resource, the CSI-IM resource, or the SSB resource associated with the CSI report may refer to a CSI-RS resource, a CSI-IM resource, or an SSB resource included in a resource set configured in a resource setting referred to by a report setting for the CSI report of the UE configured via higher-layer signaling, a CSI-RS resource, a CSI-IM resource, or an SSB resource referred to by a CSI report trigger state including a parameter for the CSI report, or a CSI-RS resource, a CSI-IM resource, or an SSB resource indicated by an ID of a reference signal (RS) group.

In embodiments of the disclosure, CSI-RS/CSI-IM/SSB occasions may refer to transmission time points of CSI-RS/CSI-IM/SSB resource(s) determined by a higher-layer configuration or a combination of a higher-layer configuration and DCI triggering. For example, a slot in which transmission is performed according to a slot periodicity and a slot offset configured via higher-layer signaling is determined for the semi-persistent or periodic CSI-RS resource, and transmission symbol(s) within the slot are determined by referring to one of methods of resource mapping in the slot in Table 25 according to resource mapping information (resourceMapping). As another example, a slot in which transmission is performed according to a slot offset with respect to a PDCCH including DCI indicating channel reporting configured via higher-layer signaling is determined for an aperiodic CSI-RS resource, and transmission symbol(s) within the slot may be determined by referring to one of methods of resource mapping in the slot in Table 25 according to resource mapping information (resourceMapping).

The CSI-RS occasion described above may be determined by independently considering a transmission time point of each CSI-RS resource or by collectively considering transmission time points of one or more CSI-RS resource(s) included in a resource set, and therefore the following two analyses are possible for a CSI-RS occasion corresponding to each resource set configuration.

Analysis 1-1: from a start time point of an earliest symbol, in which one specific resource among one or more CSI-RS resources is transmitted, to an end time point of a last symbol in which the one specific resource is transmitted, the one or more CSI-RS resources being included in resource set(s) configured in a resource setting referred to by a report setting configured for a CSI report

Analysis 1-2: from a start time point of an earliest symbol, in which a CSI-RS resource transmitted at an earliest time point among all CSI-RS resources is transmitted, to an end time point of a last symbol in which a CSI-RS resource transmitted at a last time point is transmitted, all the CSI-RS resources being included in resource set(s) configured in a resource setting referred to by a report setting configured for a CSI report

Hereinafter, in embodiments of the disclosure, both the two analyses for a CSI-RS occasion can be considered and separately applied. In addition, for a CSI-IM occasion and an SSB occasion, both the two analyses can be considered as in the CSI-RS occasion. However, since the principle thereof is similar to the description above, any redundant description hereinafter will be omitted.

In embodiments of the disclosure, “CSI-RS, CSI-IM, SSB occasions for CSI report #X transmitted in uplink slot n′” refer to a set of a CSI-RS occasion, a CSI-IM occasion, and an SSB occasion which are not later than a CSI reference resource of CSI report #X transmitted in uplink slot n′ among CSI-RS occasions, CSI-IM occasions, and SSB occasions of CSI-RS resources, CSI-IM resources, and SSB resources which are included in a resource set configured in a resource setting referred to by a report setting configured for CSI report #X.

In embodiments of the disclosure, two analyses are possible for “a last CSI-RS, CSI-IM, or SSB occasion among CSI-RS, CSI-IM, or SSB occasions for CSI report #X transmitted in uplink slot n′” as follows.

Analysis 2-1: a set of occasions including a last CSI-RS occasion among CSI-RS occasions for CSI report #X transmitted in uplink slot n′, a last CSI-IM occasion among CSI-IM occasions for CSI report #X transmitted in uplink slot n′, and a last SSB occasion among SSB occasions for CSI report #X transmitted in uplink slot n′.

Analysis 2-2: a last occasion among all CSI-RS occasions, CSI-IM occasions, and SSB occasions for CSI report #X transmitted in uplink slot n′

Hereinafter, in embodiments of the disclosure, both the two analyses for “the last CSI-RS, CSI-IM, or SSB occasion among the CSI-RS, CSI-IM, or SSB occasions for CSI report #X transmitted in uplink slot n′” can be considered and separately applied. In addition, when the two analyses (analysis 1-1 and analysis 1-2) described above are considered for the CSI-RS occasion, the CSI-IM occasion, and the SSB occasion, for “the last CSI-RS, CSI-IM, or SSB occasion among the CSI-RS, CSI-IM, or SSB occasions for CSI report #X transmitted in uplink slot n′” in embodiments of the disclosure, all the four different analyses (applying analysis 1-1 and analysis 2-1, applying analysis 1-1 and analysis 2-2, applying analysis 1-2 and analysis 2-1, and applying analysis 1-2 and analysis 2-2) can be considered and separately applied.

The base station may indicate CSI reporting by considering an amount of channel information that may be computed concurrently by the UE for the CSI report, i.e., the number of channel information computation units (CSI processing units (CPUs)) of the UE. If the number of channel information computation units that the UE is able to concurrently compute is N_{CPU}, the UE may not expect a CSI report indication of the base station, which requires channel information computation more than N_{CPU}, or may not consider updating of channel information which requires channel information computation more than N_{CPU}. N_{CPU} may be reported by the UE to the base station via higher-layer signaling or may be configured by the base station via higher-layer signaling.

The CSI reporting indicated by the base station to the UE is assumed to occupy all or some of CPUs for channel information computation among a total number N_{CPU} of pieces of channel information that the UE is able to concurrently compute. For each CSI report, for example, if the number of channel information computation units required for CSI report n (n=0, 1, . . . , N−1) is

$${O}_{CPU}^{( n )} ,$$

then the number of channel information computation units required for a total of N CSI reports may be

$${\sum }_{n = 0}^{N - 1} {O}_{CPU}^{( n )} .$$

A channel information computation unit required for each reportQuantity configured in the CSI report may be configured as shown in Table 30.

TABLE 30

$- {O}_{CPU}^{( n )} = 0 : a case where reportQuantity configured in a CSI report is$
configured as “none”, and trs-Info is configured in a CSI-RS resource set
connected to the CSI report
$- {O}_{CPU}^{( n )} = 1 : a case where reportQuantity configured in a CSI report is$
configured as “none”, “cri-RSRP”, or “ssb-Index-RSRP”, and trs-Info is
not configured in a CSI-RS resource set connected to the CSI report
- a case where reportQuantity configured in a CSI report is configured as
“cri-RI-PMI-CQI”, “cri-RI-il”, “cri-RI-il-CQI”, “cri-RI-CQI”, or ″cri-
RI-LI-PMI-CQI”
$>> {O}_{CPU}^{( n )} = {N}_{CPU} : a case where aperiodic CSI reporting is triggered and a$
corresponding CSI report is not multiplexed with one or both of a TB and
an HARQ-ACK. a case where the CSI report is wideband CSI,
corresponds to up to 4 CSI-RS ports, and corresponds to a single resource
with no CRI report, and codebookType corresponds to “typeI-
SinglePanel” or reportQuantity corresponds to “cri-RI-CQI” (this case
corresponds to delay requirement 1 described above and may be seen as
a case where the UE uses all available CPUs to rapidly calculate and then
report CSI)
$>> {O}_{CPU}^{( n )} = {K}_{s} : all cases remaining after excluding the case above . {K}_{s}$
indicates the number of CSI-RS resources in a CSI-RS resource set for
channel measurement.

If the number of channel information computations that the UE requires for multiple CSI reports at a specific time point is greater than the number NCPU of channel information computation units that the UE is able to concurrently compute, the UE may not consider updating of channel information for some CSI reports. Among the indicated multiple CSI reports, a CSI report for which updating of channel information is not considered may be determined by at least considering a time during which channel information computation required for the CSI report occupies CPUs and a priority of channel information to be reported. For example, for the time during which channel information computation required for the CSI report occupies the CPUs, updating of channel information for a CSI report starting at a last time point may not be considered, and giving no priority to updating of channel information for a CSI report having a low priority of channel information is possible. The channel information priority may be determined by referring to Table 31.

TABLE 31
CSI priority value Pri_{iCSI} (y, k, c, s) = 2 · N_{cells} · Mₛ · y + N_{cells} · Mₛ · k +
Mₛ · c + s,
a case of aperiodic CSI report transmitted via y = 0 PUSCH, a case of
semi-persistent CSI report transmitted via y = 1 PUSCH, a case of semi-
persistent CSI report transmitted via y = 2 PUCCH, a case of periodic
CSI report transmitted via y = 3 PUCCH;
a case where k = 0 CSI report includes L1-RSRP, a case where k = 1 CSI
report does not include L1-RSRP;
c: a serving cell index, N_{cells}: the maximum number of serving cells
configured via higher-layer signaling (maxNrofServingCells);
s: a CSI report configuration index (reportConfigID), Mₛ: the maximum
number of CSI report configurations configured via higher-layer signaling
(maxNrofCSI-ReportConfigurations).

A CSI priority for a CSI report may be determined via priority values Pri_{iCSI}(y, k, c, s) of Table 31. Referring to Table 31, a CSI priority value may be determined via a type of channel information included in the CSI report, time domain report characteristics (aperiodic, semi-persistent, or periodic) of the CSI report, a channel (PUSCH or PUCCH) on which the CSI report is transmitted, a serving cell index, and a CSI report configuration index. For the CSI priority of the CSI report, the priority values Pri_{iCSI}(y, k, c, s) are compared so that a CSI report having a smaller priority value is determined to have a higher CSI priority. When a time during which channel information computation required for a CSI report indicated by the base station to the UE occupies CPUs is a CPU occupation time, the CPU occupation time is determined by considering a type (report quantity) of channel information included in the CSI report, time domain characteristics (aperiodic, semi-persistent, or periodic) of the CSI report, a slot or a symbol occupied by higher-layer signaling or DCI indicating the CSI report, and some or all of slots or symbols occupied by a reference signal for channel state measurement.

A combination of a CSI reporting setting and a CSI resource setting may be supported based on Table 32 below.

TABLE 32

| CSI-RS | | | |
|---|---|---|---|
| Config- | Periodic CSI | Semi-Persistent CSI | Aperiodic CSI |
| uration | Reporting | Reporting | Reporting |
| Periodic | No dynamic | For reporting on | Triggered by DCI; |
| CSI-RS | triggering/ | PUCCH, the UE | additionally, |
| | activation | receives an | activation |
| | | activation command | command [10, TS |
| | | [10, TS 38.321]; for | 38.321] possible as |
| | | reporting on PUSCH, | defined in |
| | | the UE receives | Subclause |
| | | triggering on DCI | 5.2.1.5.1. |
| Semi- | Not | For reporting on | Triggered by DCI; |
| Persistent | Supported | PUCCH, the UE | additionally, |
| CSI-RS | | receives an | activation |
| | | activation command | command [10, TS |
| | | [10, TS 38.321]; for | 38.321] possible as |
| | | reporting on PUSCH, | defined in |
| | | the UE receives | Subclause |
| | | triggering on DCI | 5.2.1.5.1. |
| Aperiodic | Not | Not Supported | Triggered by DCI; |
| CSI-RS | Supported | | additionally, |
| | | | activation |
| | | | command [10, TS |
| | | | 38.321] possible as |
| | | | defined in |
| | | | Subclause |
| | | | 5.2.1.5.1. |

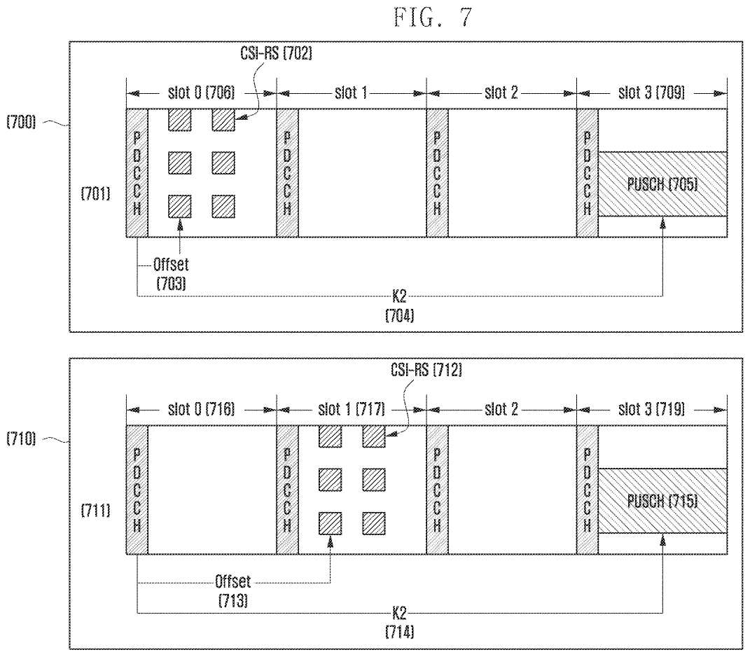

FIG. 7 is a diagram illustrating an example of an aperiodic CSI reporting method. In an example 700 of FIG. 7, a UE may acquire DCI format 0_1 by monitoring a PDCCH 701, and may acquire scheduling information and CSI request information for a PUSCH 705 from DCI format 0_1. The UE may acquire, from a received CSI request indicator, resource information of a CSI-RS 702 to be measured. The UE may determine which CSI-RS 702 resource transmitted at a specific point in time needs to be measured, based on a time point at which DCI format 0_1 is received, and a parameter for an offset (aforementioned aperiodicTriggeringOffset) in a CSI resource set configuration (e.g., an NZP CSI-RS resource set configuration (NZP-CSI-RS-ResourceSe)). More specifically, the UE may be configured with an offset value X of parameter aperiodicTriggeringOffset in the NZP-CSI-RS resource set configuration from a base station via higher-layer signaling, and the configured offset value X may indicate an offset between a slot in which DCI triggering aperiodic CSI reporting is received, and a slot in which the CSI-RS resource is transmitted. For example, the parameter value of aperiodicTriggeringOffset and offset value X may have a mapping relation therebetween as shown in Table 33 below.

TABLE 33

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

The example 700 of FIG. 7 shows an example in which offset value X described above is configured so that X=0. In this case, the UE may receive the CSI-RS 702 in a slot (corresponding to slot 0 706 in the example 700) in which DCI format 0_1 triggering aperiodic CSI reporting is received, and may report CSI information, which is measured based on the received CSI-RS, to the base station via the PUSCH 705. The UE may acquire scheduling information (information corresponding to each field of DCI format 0_1 described above) on the PUSCH 705 for CSI reporting from DCI format 0_1. For example, in DCI format 0_1, the UE may acquire information on a slot, in which the PUSCH 705 is to be transmitted, from time domain resource allocation information for the PUSCH 705. In the example 700, the UE acquires 3 as a K2 value corresponding to a slot offset value for PDCCH-to-PUSCH, and accordingly, the PUSCH 705 may be transmitted in slot 3 709, which is spaced 3 slots apart from slot 0 706, i.e., a time point at which the PDCCH 701 has been received. In an example 710 of FIG. 7, the UE may acquire DCI format 0_1 by monitoring a PDCCH 711, and may acquire scheduling information and CSI request information for a PUSCH 715 from DCI format 0_1. The UE may acquire, from a received CSI request indicator, resource information of a CSI-RS 712 to be measured. The example 710 of FIG. 7 shows an example in which offset value X for the CSI-RS is configured so that X=1. In this case, the UE may receive the CSI-RS 712 in a slot (corresponding to slot 0 716) in which DCI format 0_1 triggering aperiodic CSI reporting is received, and may report CSI information, which is measured based on the received CSI-RS, to the base station via the PUSCH 715.

An aperiodic CSI report may include at least one of or both CSI part 1 and CSI part 2, and when the aperiodic CSI report is transmitted via a PUSCH, the aperiodic CSI report may be multiplexed on a TB. For multiplexing, a CRC may be inserted into input bits of aperiodic CSI, may undergo encoding and rate matching, and then may be mapped to an RE in the PUSCH in a specific pattern so as to be transmitted. The CRC insertion may be omitted depending on a coding method or a length of the input bits. The number of modulation symbols, which is calculated for rate matching during multiplexing of CSI part 1 or CSI part 2 included in the aperiodic CSI report, may be calculated as shown below.

```
For CSI part 1 transmission on PUSCH not using repetition type B with UL-SCH, the number of coded
$modulation symbols per layer for CSI part I transmission , denoted as {Q}_{CSI - part}^{′} , is determined as follows :$
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ \cdot ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$
. . .
For CSI part 1 transmission on an actual repetition of a PUSCH with repetition Type B with UL-SCH, the
$number of coded modulation symbols per layer for CSI part 1 transmission , denoted as {Q}_{CSI - part 1}^{′} , is determined$
as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ \cdot ⌈ α \cdot {\sum }_{l = 0}^{{N}_{symb , nominal}^{PUSCH} - 1} {M}_{sc , nominal}^{UCI} ( l ) ⌉ -$ ${Q}_{ACK / CG - UCI}^{′} \cdot {\sum }_{l = 0}^{{N}_{symb , actual}^{PUSCH} - 1} {M}_{sc , actual}^{UCI} ( l ) - {Q}_{ACK / CG - UCI}^{′} \}$
. . .
For CSI part 1 transmission on PUSCH without UL-SCH, the number of coded modulation symbols per layer for
$CSI part 1 transmission , denoted as {Q}_{CSI - part 1}^{′} , is determined as follows :$
if there is CSI part 2 to be transmitted on the PUSCH,
  ${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ \cdot {\sum }_{l = 0}^{{N}_{symb , all}^{PUSCH} - 1} {M}_{sc}^{UCI} ( l ) - {Q}_{ACK}^{′} \}$
else
      ${Q}_{CSI - 1}^{′} = {\sum }_{l = 0}^{{N}_{symb , all}^{PUSCH} - 1} {M}_{sc}^{UCI} ( l ) - {Q}_{ACK}^{′}$
end if
. . .
For CSI part 2 transmission on PUSCH not using repetition type B with UL-SCH, the number of coded
$modulation symbols per layer for CSI part 2 transmission , denoted as {Q}_{CSI - part 2}^{′} , is determined as follows :$
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ \cdot$ $⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$
For CSI part 2 transmission on an actual repetition of a PUSCH with repetition Type B with UL-SCH, the
$number of coded modulation symbols per layer for CSI part 2 transmission , denoted as {Q}_{CSI - part 2}^{′} , is determined$
as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ \cdot ⌈ α \cdot {\sum }_{l = 0}^{{N}_{symb , nominal}^{PUSCH} - 1} {M}_{sc , nominal}^{UCI} ( l ) ⌉$
      $- {Q}_{ACK / CG - UCI}^{′} \cdot {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$
. . .
For CSI part 2 transmission on PUSCH without UL-SCH, the number of coded modulation symbols per layer for
$CSI part 2 transmission , denoted as {Q}_{CSI - part 2}^{′} , is determined as follows :$
${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$
```

Specifically, for repeated PUSCH transmission types A and B, the UE may multiplex the aperiodic CSI report only on a first repeated transmission among repeated PUSCH transmissions, so as to transmit the same. This is because aperiodic CSI report information that is multiplexed is encoded in a polar code scheme, and in this case, in order to perform multiplexing during multiple PUSCH repetitions, each PUSCH repetition should have the same frequency and time resource allocation. In particular, for repeated PUSCH transmission type B, since each actual repetition may have a different OFDM symbol length, the aperiodic CSI report may be multiplexed and transmitted only on the first PUSCH repetition.

In addition, for repeated PUSCH transmission type B, when the UE receives DCI for scheduling of aperiodic CSI reporting or activating of semi-persistent CSI reporting without scheduling of a TB, even if the number of repeated PUSCH transmission times configured via higher-layer signaling is greater than 1, a value of nominal repetition may be assumed to be 1. In addition, when the UE performs, based on repeated PUSCH transmission type B, scheduling or activation of aperiodic or semi-persistent CSI reporting without scheduling of a TB, the UE may expect that a first nominal repetition is the same as a first actual repetition. For a PUSCH transmitted with semi-persistent CSI based on repeated PUSCH transmission type B without scheduling of DCI after semi-persistent CSI reporting is activated via the DCI, if a first nominal repetition is different from a first actual repetition, transmission for the first nominal repetition may be ignored.

In the following description of the disclosure, upper layer signaling may refer to signaling corresponding to at least one signaling among the following signaling, or a combination of one or more thereof.
MIB
SIB or SIB X (X=1, 2, . . . )
RRC signaling
MAC CE
UE capability reporting
UE assistance information or message

In addition, L1 signaling may refer to signaling corresponding to at least one signaling method among signaling methods using the following physical layer channels or signaling, or a combination of one or more thereof.
PDCCH
DCI
UE-specific DCI
Group common DCI
Common DCI

Scheduling DCI (for example, DCI used for the purpose of scheduling downlink or uplink data)
Non-scheduling DCI (for example, DCI not used for the purpose of scheduling downlink or uplink data)
PUCCH
UCI

### First Example: Method of Configuring Interference Measurement Resources

As an example of the disclosure, a description is provided for a method of configuring interference measurement resources (CSI-IM) via higher-layer signaling in the wireless communication system.

A UE may be configured with one or multiple interference measurement resource sets via higher-layer signaling parameter CSI-IM-ResourceSet. Each interference measurement resource set may include one or more interference measurement resources. The following parameters are parameters configured in higher-layer signaling parameter CSI-IM-Resource, and a description for each parameter may be as follows.
csi-IM-ResourceId: csi-IM-ResourceId may indicate an index number of an interference measurement resource.
csi-IM-ResourceElementPattern: csi-IM-ResourceElementPattern may indicate a pattern on time and frequency resources of an interference measurement resource, and may be one of pattern0 or pattern1.
If csi-IM-ResourceElementPattern is configured to be pattern0, higher-layer signaling subcarrierLocation-p0 and symbolLocation-p0 may indicate a subcarrier position and a symbol position within a slot of the interference measurement resource, respectively, and these parameters may be used for pattern0.
   subcarrierLocation-p0 may be one value among s0, s2, s4, s6, s8, and s10, which may be a relative position from a lowest subcarrier within a specific PRB. For example, if a value of subcarrierLocation-p0 is s4, this may correspond to subcarrier 4 within the specific PRB.
   symbolLocation-p0 may be one value among integers 0, . . . , 12, which may indicate a symbol position within a specific slot.
If csi-IM-ResourceElementPattern is configured to be pattern1, higher-layer signaling subcarrierLocation-p1 and symbolLocation-p1 may indicate a subcarrier position and a symbol position within a slot of the interference measurement resource, respectively, and these parameters may be used for pattern1.
   subcarrierLocation-p1 may be one value among s0, s4, and s8, which may be a relative position from a lowest subcarrier within a specific PRB. For example, if a value of subcarrierLocation-p1 is s8, this may correspond to subcarrier 8 within the specific PRB.
   symbolLocation-p1 may be one value among integers 1, . . . , 13, which may indicate a symbol position within a specific slot.
periodicity AndOffset: If an interference measurement resource is a periodic and semi-persistent interference measurement resource, this parameter may indicate a periodicity and a slot offset of the interference measurement resource.
freqBand: freqBand may indicate a frequency resource setting of a interference measurement resource.
   freqBand may have a value of higher-layer signaling CSI-Frequency Occupation.
   Higher-layer signaling startingRB in CSI-FrequencyOccupation may indicate a starting RB position where the interference measurement resource is transmitted, and among 0 to 274, only values corresponding to multiples of 4, including 0, may be possible. The starting RB position may be determined based on common resource block (CRB) 0.
   Higher-layer signaling nrofRBs in CSI-FrequencyOccupation may indicate the number of RBs occupied by the interference measurement resource, and among 24 to 276, only values corresponding to multiples of 4 may be possible. If a setting value of nrofRBs is greater than a size of a BWP, the UE may assume that an actual length of the interference measurement resource is equal to a length of the BWP. In other words, the UE may determine a smaller value between 24 and the size of the BWP to be a minimum value of the actual number of RBs occupied by the interference measurement resource.

If the UE is configured with resourceForChannelMeasurement and csi-IM-ResourceForInterference as two parameters of CSI-ResourceConfig configured in higher-layer signaling CSI-ReportConfig, respectively, the UE may be configured with information on a channel state information measurement resource (CSI-RS for channel measurement) via resourceForChannelMeasurement, and may be configured with information on an interference measurement resource via csi-IM-ResourceForInterference. In this case, the channel state information measurement resource and the interference measurement resource can be configured to be aperiodic, semi-persistent, and periodic.
The UE may be configured with multiple channel state information measurement resource sets in higher-layer signaling resourceForChannelMeasurement, and multiple channel state information measurement resources may be configured in each channel state information measurement resource set.
The UE may be configured with multiple interference measurement resource sets in higher-layer signaling csi-IM-ResourceForInterference, and multiple interference measurement resources may be configured in each interference measurement resource set.
The UE may expect that the number of channel state information measurement resources (in a channel state information measurement resource set) and the number of interference measurement resources (in an interference measurement resource set) configured from the base station are the same, and channel state information measurement resources in one channel state information measurement resource set and interference measurement resources in one interference measurement resource set may be sequentially connected and used in pairs. For example, channel state information measurement resources 0 to N−1 are configured in a channel state information measurement resource set, interference measurement resources 0 to N−1 are configured in an interference measurement resource set, an x-th channel state information measurement resource and an x-th interference measurement resource may be connected to each other, and x may be one value among 0 to N−1.

Based on the higher-layer signaling described above, the UE may be configured with time and frequency resource positions of each channel measurement resource and each interference measurement resource, and the UE may measure interference power in time and frequency resources where the interference measurement resource is located, apply the interference power when generating channel state information, and report this to the base station via reporting of connected channel state information.

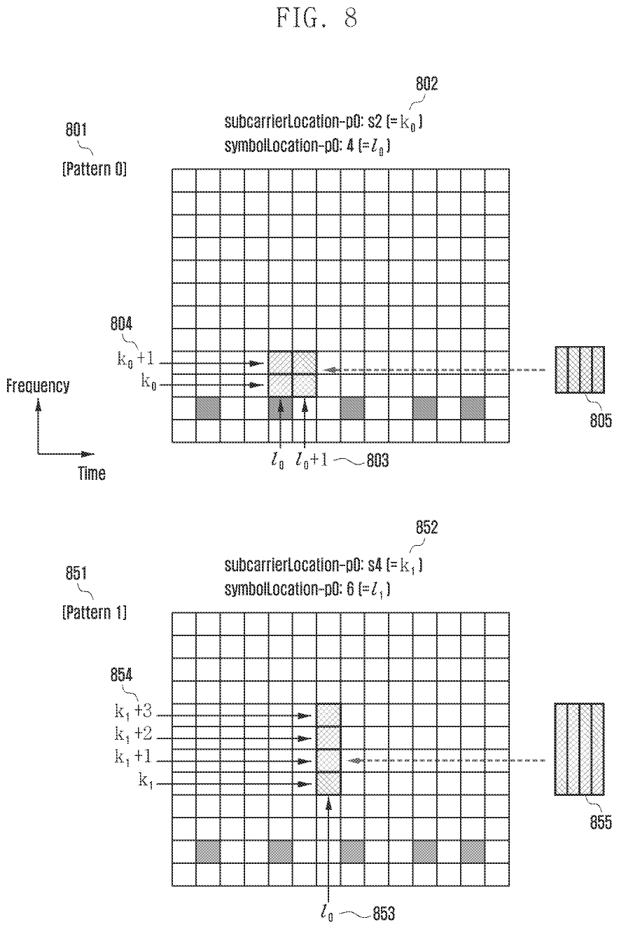

FIG. 8 is a diagram illustrating an example of two patterns of interference measurement resources according to the disclosure. A UE may determine a time and frequency domain resource position of an interference measurement resource to be pattern 0 801 or pattern 1 851 depending on whether higher-layer signaling csi-IM-ResourceElementPattern is configured to be pattern0 or pattern1.

If the UE has been configured with an interference measurement resource corresponding to pattern 0 from a base station, the UE may be configured with k₀ and l₀ 802 as corresponding higher-layer signaling subcarrierLocation-p0 and symbolLocation-p0, respectively. In this case, based on configured k₀ and l₀ values, the interference measurement resource of pattern 0 may have a square-shaped time and frequency resource position using symbols l₀ and l₀+1 803 and subcarriers k₀ and k₀+1 804. If there is a twofold difference between a subcarrier spacing of a serving cell of the UE and that of an adjacent cell, that is, if the subcarrier spacing of the adjacent cell is two times the subcarrier spacing of the serving cell, when measuring the interference power 805 received from the adjacent cell, interference measurement may be performed using two consecutive subcarriers within the serving cell by considering that there is a twofold difference in size between the subcarriers.

If the UE has been configured with an interference measurement resource corresponding to pattern 1 from the base station, the UE may be configured with k₁ and l₁ 852 as higher-layer signaling subcarrierLocation-p1 and symbolLocation-p1, respectively. In this case, based on configured k₁ and l₁ values, the interference measurement resource of pattern 1 may have a rectangular-shaped time and frequency resource position using symbol l₁ 853 and subcarriers k₁, k₁+1, k₁+2, and k₁+3 854. If there is a fourfold difference between a subcarrier spacing of a serving cell of the UE and that of an adjacent cell, that is, if the subcarrier spacing of the adjacent cell is four times the subcarrier spacing of the serving cell, when measuring the interference power 855 received from the adjacent cell, interference measurement may be performed using four consecutive subcarriers within the serving cell by considering that there is a fourfold difference in size between the subcarriers.

### Second Example: Another Method of Configuring Interference Measurement Resources

As an example of the disclosure, a description is provided for another method of configuring interference measurement resources in the wireless communication system. Based on the first example, a UE may be configured with pattern 0 or pattern 1 for an interference measurement resource, and each of pattern 0 and pattern 1 may be available when there is a twofold difference or a fourfold difference between a subcarrier spacing of a serving cell where the UE exists and a subcarrier spacing of an adjacent cell thereof, that is, when the subcarrier spacing of the adjacent cell is 2 times or 4 times larger than that of the serving cell.

In frequency range 1 (FR1), possible subcarrier spacings may be 15 kHz, 30 kHz, and 60 kHz, and in frequency range 2-1 (FR 2-1) which indicates a range where a center frequency is 6 GHz or higher and lower than 52.6 GHz, possible subcarrier spacings may be 60 kHz and 120 kHz. In frequency range 2-2 (FR2-2) indicating a range of 52.6 GHz or higher, an available bandwidth is wide so that a large number of subcarriers are required if a relatively small subcarrier spacing is used, and in order to overcome this, it may be necessary to use a value larger than an FFT size of 4096 used in the existing 5G communication system. In this case, if the existing maximum FFT size is reused, new subcarrier spacings, such as 480 kHz and 960 kHz, which are larger than the existing maximum subcarrier spacing of 120 kHz may be required. Based on this, in 5G Release 17, new subcarrier spacings, such as 480 kHz and 960 kHz, are defined to reuse the maximum FFT size in frequency range 2-2.

Accordingly, in frequency range 2-2, up to an eightfold difference may be possible between a smallest subcarrier spacing and a largest subcarrier spacing, which may exist within a specific band. Therefore, up to an eightfold difference may be possible between a subcarrier spacing of a serving cell and that of an adjacent cell. As in the first example described above, the interference measurement resource may support two patterns of pattern 0 and pattern 1, and according to the two patterns, the interference powers of the adjacent cell may be measured via 2 and 4 consecutive subcarriers, respectively. That is, the interference measurement resource of the first example may have configurations corresponding to cases where the subcarrier spacing of the adjacent cell is 2 times and 4 times the subcarrier spacing of the serving cell. Therefore, descriptions will be provided for various methods capable of configuring an interference measurement resource for a case where there is a fourfold difference between a subcarrier spacing of a serving cell and that of an adjacent cell.

### [Interference Measurement Resource Configuration Method 1]

A UE may be configured with a new pattern for an interference measurement resource from a base station. In addition to existing pattern 0 and pattern 1, the UE may be configured with at least one new pattern (for example, pattern 2 or 3, or a pattern with a different name is not excluded) from the base station. Accordingly, the aforementioned higher-layer signaling structure for the interference measurement resource may be modified or added as follows.
csi-IM-ResourceElementPattern: csi-IM-ResourceElementPattern may indicate a pattern on time and frequency resources of an interference measurement resource, and may be one value among pattern0, pattern1, pattern2, and pattern3.
   If at least one of patterns other than pattern0 or pattern1 is supported, the base station may configure, for the UE, a pattern other than pattern0 or pattern1 by using higher-layer signaling referred to as csi-IM-ResourceElementPattern or using new higher-layer signaling such as csi-IM-ResourceElementPattern-r18. Alternatively, higher-layer signaling with a different name is not excluded.
   For example, if the UE is configured with pattern2, higher-layer signaling subcarrierLocation-p2 and symbolLocation-p2 may indicate a subcarrier position and a symbol position within a slot of the interference measurement resource, respectively, and these parameters may be used for pattern2.
      subcarrierLocation-p2 may be one value among s0, s1, s2, s3, s4, s5, and s6, which may be a relative position from a lowest subcarrier within a specific PRB. For example, if a value of subcarrierLocation-p2 is s4, this may correspond to subcarrier 4 within the specific PRB. Alternatively, the disclosure is not limited to the values of s0 to s6 proposed above.
      symbolLocation-p2 may be one value among integers 0, . . . , 13, which may indicate a symbol position within a specific slot. Alternatively, the disclosure may not be limited to the proposed values.
   For example, if the UE is configured with pattern3, higher-layer signaling subcarrierLocation-p3 and symbolLocation-p3 may indicate a subcarrier position and a symbol position within a slot of the interference measurement resource, respectively, and these parameters may be used for pattern3.
      subcarrierLocation-p3 may be one value among s0, s1, . . . , s13, which may be a relative position from a lowest subcarrier within a specific PRB. For example, if a value of subcarrierLocation-p3 is s4, this may correspond to subcarrier 4 within the specific PRB. Alternatively, the disclosure may not be limited to the proposed values.
      symbolLocation-p3 may be one value among 0, 1, 2, 3, 4, 5, and 6, which may indicate a symbol position within a specific slot. Alternatively, the disclosure may not be limited to the proposed values.

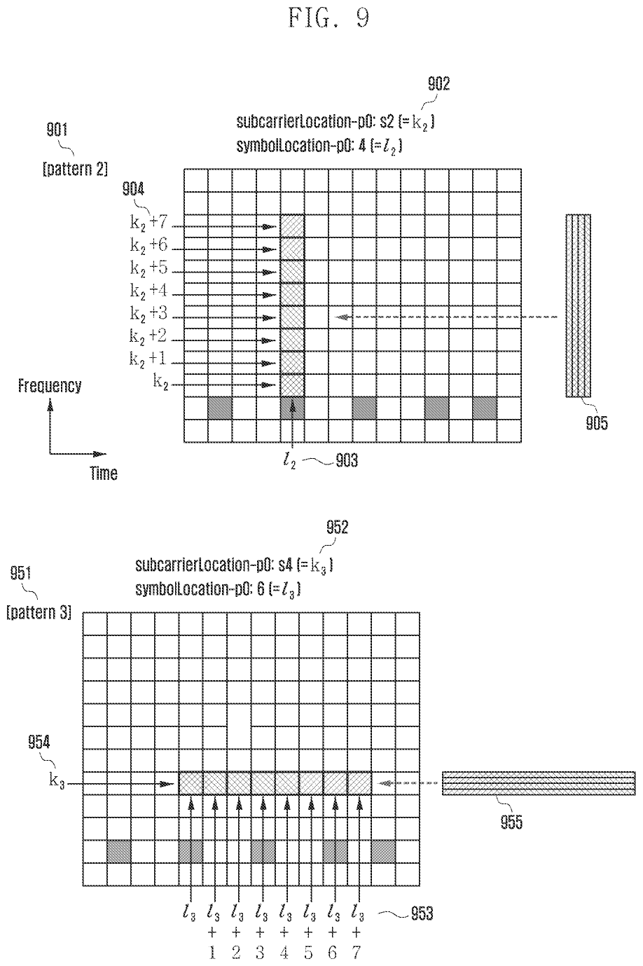

FIG. 9 is a diagram illustrating an example of new patterns of interference measurement resources according to the disclosure. A UE may determine a time and frequency domain resource position of an interference measurement resource to be pattern 2 901 or pattern 3 951 according to higher-layer signaling csi-IM-ResourceElementPattern or csi-IM-ResourceElementPattern-r18 being configured to be pattern2 or pattern3.

If the UE has been configured with an interference measurement resource corresponding to pattern 2 from the base station, the UE may be configured with k₂ and l₂ 902 as higher-layer signaling subcarrierLocation-p2 and symbolLocation-p2, respectively. In this case, based on configured k₂ and 12 values, the interference measurement resource of pattern 2 may have a rectangular-shaped time and frequency resource position using symbol l₂ 903 and subcarriers k₂, k₂+1, k₂+2, k₂+3, k₂+4, k₂+5, k₂+6, and k₂+7 904. If there is an eightfold difference between a subcarrier spacing of a serving cell of the UE and that of an adjacent cell, that is, if the subcarrier spacing of the adjacent cell is eight times the subcarrier spacing of the serving cell, when measuring the interference power 905 received from the adjacent cell, interference measurement may be performed using eight consecutive subcarriers within the serving cell by considering that there is an eightfold difference in size between the subcarriers.

If the UE has been configured with an interference measurement resource corresponding to pattern 3 from the base station, the UE may be configured with k₃ and l₃ 952 as higher-layer signaling subcarrierLocation-p3 and symbolLocation-p3, respectively. In this case, based on configured k₃ and l₃ values, the interference measurement resource of pattern 3 may have a rectangular-shaped time and frequency resource position using symbols l₃, l₃+1, l₃+2, l₃+3, l₃+4, l₃+5, l₃+6, and l₃+7 953 and subcarrier k₃ 954. If there is an eightfold difference between a subcarrier spacing of a serving cell of the UE and that of an adjacent cell, that is, if the subcarrier spacing of the serving cell is eight times the subcarrier spacing of the adjacent cell, when measuring the interference power 955 received from the adjacent cell, interference measurement may be performed using eight consecutive subcarriers within the serving cell by considering that there is an eightfold difference in size between the subcarriers.

### [Interference Measurement Resource Configuration Method 2]

A UE may be configured with an interference measurement resource of a new pattern from a base station by reusing, as much as possible, higher-layer signaling corresponding to existing pattern 0 and pattern 1 for the interference measurement resource. Accordingly, the aforementioned higher-layer signaling structure for the interference measurement resource may be modified or added as follows.
csi-IM-ResourceElementPattern: csi-IM-ResourceElementPattern may indicate a pattern on time and frequency resources of an interference measurement resource, and may be one of pattern0 or pattern1.
   The UE may be configured with new higher-layer signaling from the base station, and the higher-layer signaling may indicate to configure an interference measurement resource of a new pattern by reusing a pattern that the existing interference measurement resource may have.
      If the new higher-layer signaling is not configured, when the UE is configured with pattern0 or pattern1 for the interference measurement resource from the base station, the UE may understand pattern0 or pattern1 of the interference measurement resource as shown in the first example.
      If the new higher-layer signaling is configured, when the UE is configured with pattern0 or pattern1 for the interference measurement resource from the base station, the UE may understand pattern0 or pattern1 of the interference measurement resource as follows.
   If the UE is configured with pattern0 and configured with the new higher-layer signaling, the UE may further be configured with higher-layer signaling as follows in addition to existing higher-layer signaling subcarrierLocation-p0 and symbolLocation-p0.
      subcarrierLocation-p0 may be one value among s0, s2, s4, s6, s8, and s10, which may be a relative position from a lowest subcarrier within a specific PRB. For example, if a value of subcarrierLocation-p0 is s4, this may correspond to subcarrier 4 within the specific PRB.
      symbolLocation-p0 may be one value among integers 0, . . . , 12, which may indicate a symbol position within a specific slot.

The UE may be configured with higher-layer signaling from the base station, the higher-layer signaling indicating that the resource according to the aforementioned subcarrierLocation-p0 and symbolLocation-p0 values is repeated in at least one of time or frequency domains. For example, the UE may be configured with a combination of (X,Y) by the higher-layer signaling so that pattern0 indicates to perform repetition X times in the frequency domain and/or Y times in the time domain. For example, (X,Y)=(4,1), (1,4), (2,2), (2,1), . . . , etc. may be given. Alternatively, it is also possible to configure only X or Y. If X or Y is not configured, X or Y may be understood as 1. The repetition may be performed in a direction where a symbol index increases or/and in a direction where a subcarrier index increases, or vice versa.
If the UE is configured with pattern1, higher-layer signaling subcarrierLocation-p1 and symbolLocation-p1 may indicate a subcarrier position and a symbol position within a slot of the interference measurement resource, respectively, and these parameters may be used for pattern1.
   subcarrierLocation-p1 may be one value among s0, s4, and s8, which may be a relative position from a lowest subcarrier within a specific PRB. For example, if a value of subcarrierLocation-p1 is s4, this may correspond to subcarrier 4 within the specific PRB.
      symbolLocation-p0 may be one value among integers 1, . . . , 13, which may indicate a symbol position within a specific slot.
      The UE may be configured with higher-layer signaling from the base station, the higher-layer signaling indicating that the resource according to the aforementioned subcarrierLocation-p1 and symbolLocation-p1 values is repeated in at least one of time or frequency domains. The UE may be configured with a combination of (X,Y) or with X or Y by the higher-layer signaling so that pattern1 indicates to perform repetition X times in the frequency domain and/or Y times in the time domain. For example, (X,Y)=(4,1), (1,4), (2,2), (2,1), . . . , etc. may be given. Alternatively, it is also possible to configure only X or Y. If X or Y is not configured, X or Y may be understood as 1. The repetition may be performed in a direction where a symbol index increases or/and in a direction where a subcarrier index increases, or vice versa.

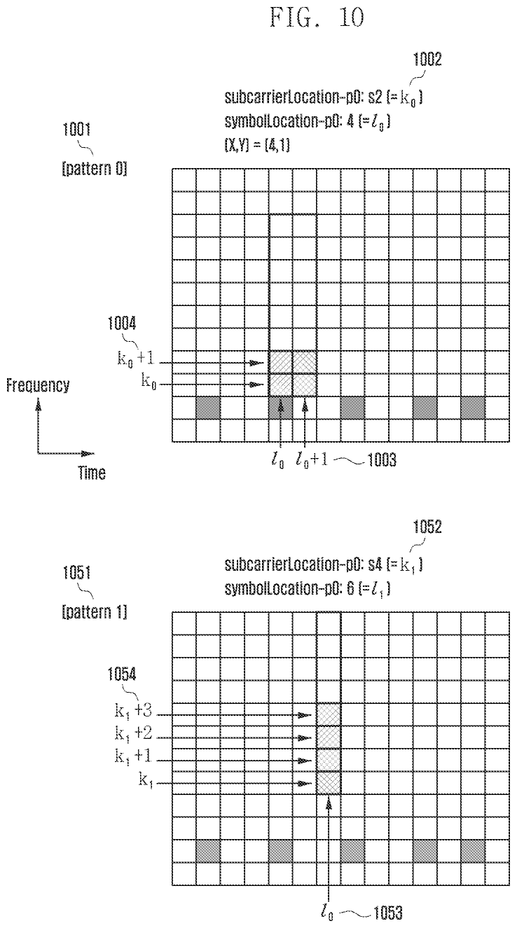

FIG. 10 is a diagram illustrating an example of new patterns of interference measurement resources according to the disclosure. A UE may determine a time and frequency domain resource position of an interference measurement resource to be pattern 0 1001 or pattern 1 1051 according to higher-layer signaling csi-IM-ResourceElementPattern being configured to be pattern0 or pattern1.

If the UE has been configured with an interference measurement resource corresponding to pattern 0 from a base station, the UE may be configured with k₀ and l₀ 1002 as higher-layer signaling subcarrierLocation-p0 and symbolLocation-p0, respectively. In this case, based on configured k₀ and l₀ values, the interference measurement resource of pattern 0 may have a square-shaped time and frequency resource position using symbols l₀ and l₀+1 1003 and subcarriers k₀ and k₀+1 1004. In addition, if the UE is configured with (4,1) 1002 as the value of (X,Y) from the base station, the interference measurement resource may have a form in which the square-shaped time and frequency resource position obtained via subcarrierLocation-p0 and symbolLocation-p0 is repeated four times in the frequency domain and one time in the time domain, and the UE may perform interference measurement using this interference measurement resource position. For example, if repetition of (4,1) is configured, the UE may perform interference measurement in symbols l₀ and l₀+1 and subcarriers k₀, k₀+1, k₀+2, k₀+3, k₀+4, k₀+5, k₀+6, and k₀+7.

If the UE has been configured with an interference measurement resource corresponding to pattern 1 from the base station, the UE may be configured with k₁ and l₁ 1052 as higher-layer signaling subcarrierLocation-p1 and symbolLocation-p1, respectively. In this case, based on configured k₁ and 11 values, the interference measurement resource of pattern 1 may have a rectangular-shaped time and frequency resource position using symbol l₁ 1053 and subcarriers k₁, k₁+1, k₁+2, and k₁+3 1054. In addition, if the UE is configured with (2,1) 1052 as the value of (X,Y) from the base station, the interference measurement resource may have a form in which the rectangular-shaped time and frequency resource position obtained via subcarrierLocation-p1 and symbolLocation-p1 is repeated two times in the frequency domain and one time in the time domain, and the UE may perform interference measurement using this interference measurement resource position. For example, if repetition of (2,1) is configured, the UE may perform interference measurement in symbol l₁ and subcarriers k₁, k₁+1, k₁+2, k₁+3, k₁+4, k₁+5, k₁+6, and k₁+7.

### [Interference Measurement Resource Configuration Method 3]

For a connection relationship of a channel state information measurement resource and an interference measurement resource, a UE may expect to use multiple interference measurement resources by connecting the same to one channel state information measurement resource rather than an existing 1:1 connection relationship. The UE may be configured with different numbers of channel state information measurement resources and interference measurement resources from a base station, and the connection relationship therebetween may be configured via higher-layer signaling.

The UE may be configured with higher-layer signaling expressing a corresponding connection relationship included therein from the base station with respect to a channel state information measurement resource or a channel state information measurement resource set. The UE may be configured with higher-layer signaling expressing a corresponding connection relationship from the base station so that the higher-layer signaling expresses connections between one channel state information measurement resource set and multiple interference measurement resource sets, and configuration information of the higher-layer signaling may exist in the channel state information measurement resource set.

For example, the higher-layer signaling expressing the connection relationship may be expressed by a specific index, and the same index may be configured for the channel state information measurement resource set and the interference measurement resource set connected to each other. For example, it is possible that the same index is configured in channel state information measurement resource set configuration information and interference measurement resource set configuration information. In this case, the fact that the same index has been configured for the channel state information measurement resource set and the interference measurement resource set may indicate that the two sets are connected to each other. For example, if only one such connection relationship can exist within a cell or a BWP, higher-layer signaling that expresses the connection relationship may not be limited to a specific index and may be replaced with higher-layer signaling, such as linking=“ON”, indicating that a specific resource set corresponds to a connection relationship.

For example, a case where the same index has been configured in one channel state information measurement resource set and multiple interference measurement resource sets may indicate that one channel state information measurement resource and multiple interference measurement resources are connected to each other, and may indicate that each channel state information measurement resource in the one channel state information measurement resource set is connected to one interference measurement resource in each interference measurement resource set. In this case, the number of channel state information measurement resources in one channel state information measurement resource set and the number of interference measurement resources in every interference measurement resource sets may be the same. For example, the base station may configure, for the UE, one channel state information measurement resource set and four interference measurement resource sets as follows, in which case, the number of measurement resources for each set may be as follows.
First channel state information measurement resource set: Four channel state information measurement resources exist.
First to fourth interference measurement resource sets: Four interference measurement resources exist in each interference measurement resource set.

In the above situation, an X-th channel state information measurement resource in the first channel state information measurement resource set may be connected to an X-th interference measurement resource included in each of the first to fourth interference measurement resource sets. In this case, the channel state information measurement resource and the interference measurement resource may have a one-to-four connection relationship.

As another example, a case where the same index has been configured in one channel state information measurement resource set and one interference measurement resource set may indicate that one channel state information measurement resource in the one channel state information measurement resource set and multiple (X) interference measurement resources in the one interference measurement resource set are connected to each other. If one channel state information measurement resource and X interference measurement resources are connected, the number of interference measurement resources in one interference measurement resource set may be X times the number of channel state information measurement resources in one channel state information measurement resource set, wherein X may be configured from the base station via higher-layer signaling, dynamically indicated by L1 signaling, notified by a combination of higher-layer signaling and L1 signaling, or defined as a fixed value within the specification. In this case, the UE may assume implicit connection relationships between a Y-th channel state information measurement resource in the channel state information measurement resource set and (X(Y−1)+1)th to XY-th interference measurement resources in the interference measurement resource set, where Y may be a natural number smaller than or equal to the number of channel state information measurement resources. Alternatively, X can also be determined based on a ratio of the number of channel state information measurement resources in the channel state information measurement resource set and the number of interference measurement resources in the interference measurement resource set. In this case, the number of interference measurement resources connected to one channel state information measurement resource may vary depending on each channel state information measurement resource.

When indicating this connectivity between one channel state information measurement resource set and one interference measurement resource set, in addition to the described method of configuring the same value as an index for each resource set, the index of each of the channel state information measurement resource set and the interference measurement resource set having this connectivity may be assumed to be a lowest or highest index (for example, this may indicate that a channel state information measurement resource set with a lowest index and an interference measurement resource set with a lowest index are connected to each other).

As another example, a case where the same index has been configured for one channel state information measurement resource set and one interference measurement resource set may indicate that one channel state information measurement resource in the one channel state information measurement resource set and multiple interference measurement resources in the one interference measurement resource set are connected to each other. In this case, if one channel state information measurement resource and X interference measurement resources are connected, an index may be configured via higher-layer signaling for each of the one channel state information measurement resource and the X interference measurement resources, wherein the index in the higher-layer signaling indicates that corresponding 1+X channel state information measurement resources and interference measurement resources are connected to each other. In this case, the indexes configured for the resource sets and the indexes configured in the resources may not be related to each other.

The number of interference measurement resources in one interference measurement resource set may be X times the number of channel state information measurement resources in one channel state information measurement resource set, wherein X may be configured from the base station via higher-layer signaling, dynamically indicated by L1 signaling, notified by a combination of higher-layer signaling and L1 signaling, or defined as a fixed value within the specification. For example, the base station may configure, for the UE, three channel state information measurement resources in one channel state information measurement resource set, configure eight interference measurement resources in one interference measurement resource set, and define a connection relationship by configuring, via higher-layer signaling, a specific index in the higher-layer signaling for each channel state information measurement resource and interference measurement resource, as follows.
First channel state information measurement resource: index 0
Second channel state information measurement resource: index 1
Third channel state information measurement resource: index 2
First to third interference measurement resources: index 0
Fourth to fifth interference measurement resources: index 1
Sixth to eighth interference measurement resources: index 2

As above, when the base station has configured the index of each measurement resource for the UE via higher-layer signaling, the UE may assume that the first channel state information measurement resource has a one-to-three connection with the first to third interference measurement resources, the second channel state information measurement resource is connected to the fourth and fifth interference measurement resources, and the third channel state information measurement resource is connected to the sixth to eighth interference measurement resources.

### [Interference Measurement Resource Configuration Method 4]

When an interference measurement resource configuration is received from a base station, a UE may be configured with multiple patterns instead of being selectively configured with one of multiple patterns as before. In this case, a possible pattern may include at least one of the aforementioned patterns according to [interference measurement resource configuration method 1] or [interference measurement resource configuration method 2], a parameter, such as csi-IM-ResourceElementPattern-rXX, may be added instead of csi-IM-ResourceElementPattern that is higher-layer signaling in an interference measurement resource so that the parameter may be configured to SEQUENCE including information on the multiple patterns, and the configuration may be included in one interference measurement resource, in which case connections between channel state information measurement resources and interference measurement resources may maintain a one-to-one relationship as before.

A resource in which the UE is to perform interference measurement may be determined by a combination of at least one of interference measurement resource configuration methods 1 to 4 described above. For example, pattern2 or pattern3 may be configured according to interference measurement resource configuration method 2, and repetition of pattern2 or pattern3 in the frequency domain or/and time domain may be configured according to interference measurement resource configuration method 3.

The UE may perform UE capability reporting for at least one of [interference measurement resource configuration method 1] to [interference measurement resource configuration method 3] described above. For example, a unit of UE capability reporting may be per band, per band-per-band combination, per feature set, per feature set per cell, or per UE signaling. For example, if the unit of UE capability reporting is per band, the UE may perform the UE capability reporting only in a band defined in FR2-2. For example, if the unit of UE capability reporting is per band-per-band combination, the UE may perform the UE capability reporting when at least one band is included in FR2-2.

When the UE receives, from the base station, higher-layer signaling for at least one of aforementioned [interference measurement resource configuration method 1] to [interference measurement resource configuration method 3], the UE may expect that the higher-layer signaling is configurable only for a serving cell belonging to a band in FR2-2.

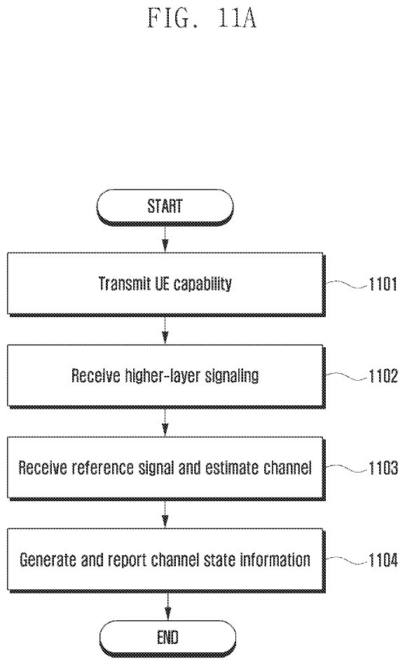

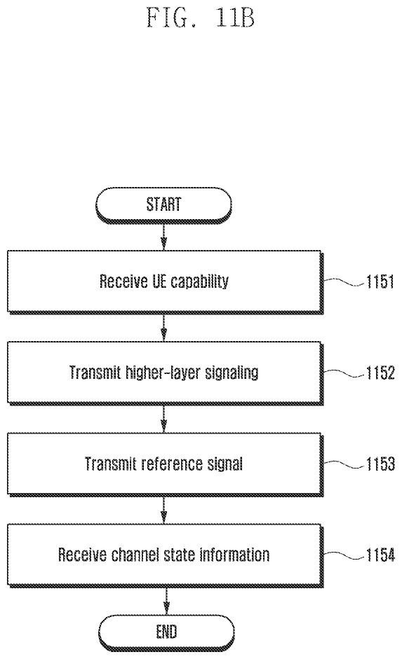

FIG. 11A is a diagram illustrating an example of an operation performed by a base station according to the disclosure.

A UE may transmit 1101 a UE capability to a base station. In this case, the UE capability may be a UE capability indicating that at least one of aforementioned [interference measurement resource configuration method 1] to [interference measurement resource configuration method 3] is supported. Then, the UE may receive 1102 higher-layer signaling from the base station. In this case, the higher-layer signaling that the UE may receive may include the aforementioned higher-layer signaling for channel state information measurement resources and sets and interference measurement resources and sets, and at least one higher-layer signaling related to [interference measurement resource configuration method 1] to [interference measurement resource configuration method 3]. Thereafter, the UE may identify resources, in which channel measurement and interference measurement will be performed, based on the higher-layer signaling received from the base station, receive a reference signal from the base station, and estimate 1103 channel information based on the measured channel and interference by using the reference signal. Then, based on this, the UE may generate channel state information and report 1104 the channel state information to the base station.

FIG. 11B is a diagram illustrating an example of an operation performed by a UE according to an example of the disclosure.

A base station may receive 1151 a UE capability from a UE. In this case, the UE capability may be a UE capability indicating that at least one of aforementioned [interference measurement resource configuration method 1] to [interference measurement resource configuration method 3] is supported. Then, the base station may transmit 1152 higher-layer signaling to the UE. In this case, the higher-layer signaling that the base station may transmit may include the aforementioned higher-layer signaling for channel state information measurement resources and sets and interference measurement resources and sets, and at least one higher-layer signaling related to [interference measurement resource configuration method 1] to [interference measurement resource configuration method 3]. Thereafter, the base station may transmit 1153 a reference signal to the UE, and then the base station may receive 1154 channel state information generated by the UE. The channel state information is generated based on measured channel and interference based on the resources for channel measurement and interference measurement, which are configured for the UE by the base station using higher-layer signaling.

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation.

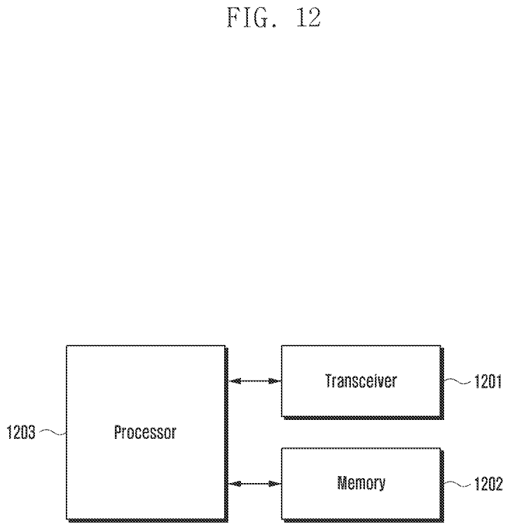

FIG. 12 is a block diagram illustrating an example of a structure of a UE according to an embodiment of the disclosure.

Referring to FIG. 12, the UE may include a transceiver 1201, a memory 1202, and a processor 1203. Components of the UE are not limited to the above-described example. For example, the UE may include a larger or smaller number of components than the above-described components. Furthermore, all or at least some of the transceiver 1201, the memory 1202, and the processor 1203 may be implemented in the form of a single chip.

In an embodiment, the transceiver 1201 may transmit/receive signals with the base station. The signals may include control information and data. To this end, the transceiver 1201 may include an RF transmitter configured to up-convert and amplify the frequency of transmitted signals, an RF receiver configured to low-noise-amplify received signals and down-convert the frequency thereof, and the like. In addition, the transceiver 1201 may receive signals through a radio channel, output the same to the processor 1203, and transmit signals output from the processor 1203 through the radio channel.

In an embodiment, the memory 1202 may store programs and data necessary for operations of the UE. In addition, the memory 1202 may store control information or data included in signals transmitted/received by the UE. The memory 1202 may include storage media such as a ROM, a RAM, a hard disk, a CD-ROM, and a DVD, or a combination of storage media. In addition, the memory 1202 may include multiple memories. According to an embodiment, the memory 1202 may store a program for performing operations for power saving of the UE.

In an embodiment, the processor 1203 may control a series of processes such that the UE can operate according to the above-described embodiments of the disclosure. In an embodiment, the processor 1203 may execute the program stored in the memory 1202 to receive configuration information for channel state information measurement from the base station and, based on the configuration information, control channel state information measurement and reporting operations.

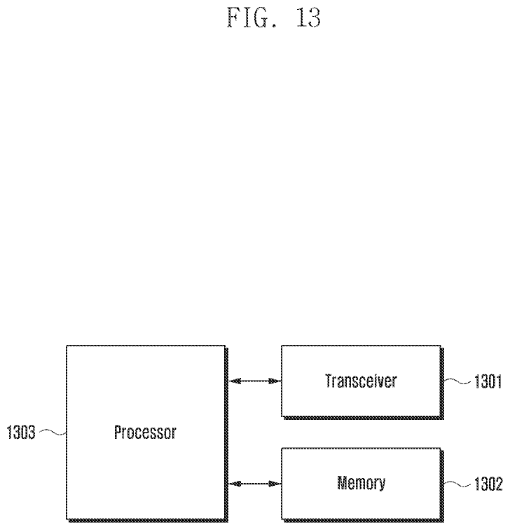

FIG. 13 is a block diagram illustrating an example of a structure of a base station according to an embodiment of the disclosure.

Referring to FIG. 13, the base station may include a transceiver 1301, a memory 1302, and a processor 1303. However, components of the base station are not limited to the above-described example. For example, the base station may include a larger or smaller number of components than the above-described components. Furthermore, the transceiver 1301, the memory 1302, and the processor 1303 may be implemented in the form of a single chip.

In an embodiment, the transceiver 1301 may transmit/receive signals with the UE. The signals may include control information and data. To this end, the transceiver 1301 may include an RF transmitter configured to up-convert and amplify the frequency of transmitted signals, an RF receiver configured to low-noise-amplify received signals and down-convert the frequency thereof, and the like. In addition, the transceiver 1301 may receive signals through a radio channel, output the same to the processor 1303, and transmit signals output from the processor 1303 through the radio channel.

In an embodiment, the memory 1302 may store programs and data necessary for operations of the base station. In addition, the memory 1302 may store control information or data included in signals transmitted/received by the base station. The memory 1302 may include storage media such as a ROM, a RAM, a hard disk, a CD-ROM, and a DVD, or a combination of storage media. In addition, the memory 1302 may include multiple memories. According to an embodiment, the memory 1302 may store a program for performing operations for power saving of the UE.

In an embodiment, the processor 1302 may control a series of processes such that the base station can operate according to the above-described embodiments. In an embodiment, the processor 1303 may execute the program stored in the memory 1302 to transmit configuration information for channel state information measurement to the UE and control channel state information reception operations.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. In addition, the embodiments of the disclosure may be applied to other communication systems and other variants based on the technical idea of the embodiments may also be implemented. For example, the embodiments may also be applied to LTE systems, 5G systems, NR systems, etc.

1. A method performed by a terminal of a communication system, the method comprising:
receiving channel state information (CSI) reporting configuration information from a base station, wherein the CSI reporting configuration information comprises information on a channel measurement resource and information on an interference measurement resource;
based on the CSI reporting configuration information, acquiring CSI by measuring a channel in the channel measurement resource and measuring interference in the interference measurement resource; and
reporting the acquired CSI to the base station,
wherein the interference measurement resource comprises at least one of eight consecutive subcarriers on one orthogonal frequency division multiplexing (OFDM) symbol or eight consecutive symbols on one subcarrier.

2. The method of claim 1, wherein the information on the interference measurement resource comprises first pattern information indicating the eight consecutive subcarriers on one OFDM symbol or second pattern information indicating the eight consecutive symbols on one subcarrier.

3. The method of claim 1, wherein the CSI reporting configuration information further comprises information indicating connections of one channel measurement resource and multiple interference measurement resources.

4. The method of claim 1, further comprising transmitting, to the base station, user equipment capability information on whether a configuration of the interference measurement resource is supported.

5. A method performed by a base station of a communication system, the method comprising:
transmitting channel state information (CSI) reporting configuration information to a terminal, wherein the CSI reporting configuration information comprises information on a channel measurement resource and information on an interference measurement resource; and
receiving CSI from the terminal,
wherein the CSI is acquired by measuring a channel in the channel measurement resource and measuring interference in the inference measurement resource, and
wherein the interference measurement resource comprises at least one of eight consecutive subcarriers on one orthogonal frequency division multiplexing (OFDM) symbol or eight consecutive symbols on one subcarrier.

6. The method of claim 5, wherein the information on the interference measurement resource comprises first pattern information indicating the eight consecutive subcarriers on one OFDM symbol or second pattern information indicating the eight consecutive symbols on one subcarrier.

7. The method of claim 5, wherein the CSI reporting configuration information further comprises information indicating connections of one channel measurement resource and multiple interference measurement resources.

8. The method of claim 5, further comprising receiving, from the terminal, user equipment capability information on whether a configuration of the interference measurement resource is supported.

9. A terminal of a communication system, the terminal comprising:
a transceiver; and
a controller configured to perform control to:
receive channel state information (CSI) reporting configuration information from a base station, wherein the CSI reporting configuration information comprises information on a channel measurement resource and information on an interference measurement resource;
based on the CSI reporting configuration information, acquire CSI by measuring a channel in the channel measurement resource and measuring interference in the interference measurement resource; and
report the acquired CSI to the base station,
wherein the interference measurement resource comprises at least one of eight consecutive subcarriers on one orthogonal frequency division multiplexing (OFDM) symbol or eight consecutive symbols on one subcarrier.

10. The terminal of claim 9, wherein the information on the interference measurement resource comprises first pattern information indicating the eight consecutive subcarriers on one OFDM symbol or second pattern information indicating the eight consecutive symbols on one subcarrier.

11. The terminal of claim 9, wherein the CSI reporting configuration information further comprises information indicating connections of one channel measurement resource and multiple interference measurement resources.

12. The terminal of claim 9, wherein the controller is further configured to perform control to transmit, to the base station, user equipment capability information on whether a configuration of the interference measurement resource is supported.

13. A base station of a communication system, the base station comprising:
a transceiver; and
a controller configured to perform control to:
transmit channel state information (CSI) reporting configuration information to a terminal, wherein the CSI reporting configuration information comprises information on a channel measurement resource and information on an interference measurement resource; and
receive CSI from the terminal,
wherein the CSI is acquired by measuring a channel in the channel measurement resource and measuring interference in the inference measurement resource, and
wherein the interference measurement resource comprises at least one of eight consecutive subcarriers on one orthogonal frequency division multiplexing (OFDM) symbol or eight consecutive symbols on one subcarrier.

14. The base station of claim 13, wherein the information on the interference measurement resource comprises first pattern information indicating the eight consecutive subcarriers on one OFDM symbol or second pattern information indicating the eight consecutive symbols on one subcarrier.

15. The base station of claim 13, wherein the CSI reporting configuration information further comprises information indicating connections of one channel measurement resource and multiple interference measurement resources.
